(19) United States
(12) Patent Application Publication
(10) Pub. No.: US 2025/0176543 A1
(43) Pub. Date: Jun. 5, 2025

(54) HERBICIDAL AND PESTICIDAL COMPOSITIONS AND METHODS OF USE THEREOF

(71) Applicant: Tu Biomics, Inc., Reno, NV (US)

(72) Inventor: Brian Speicher, Reno, NV (US)

(73) Assignee: Tu Biomics, Inc., Reno, NV (US)

(21) Appl. No.: 18/960,975

(22) Filed: Nov. 26, 2024

Related U.S. Application Data
(60) Provisional application No. 63/604,439, filed on Nov. 30, 2023.

(51) Int. Cl. A01N 37/02; A01N 31/14; A01P 5/00; A01P 13/02

(52) U.S. Cl. CPC A01N 37/02; A01N 31/14; A01P 5/00; A01P 13/02

(57) ABSTRACT

Provided herein are herbicidal compositions and methods of use thereof for the control of undesirable plants (e.g., weeds).

### CROSS REFERENCE TO RELATED APPLICATIONS

The present application claims priority to and the benefit of U.S. App. No. 63/604,439, filed Nov. 30, 2023, the contents of which is hereby incorporated by reference in its entirety.

### BACKGROUND OF THE INVENTION

Commercially available herbicidal compositions including fatty acids or organic acids are a significant presence in the herbicide market. However, these commercially available herbicides are limited in their control of weed growth and control of post-treatment re-emergence of weed populations.

Therefore, there remains a need for the development of improved herbicidal formulations including fatty acids and/or organic acids. Improved compositions for the control of other pests, such as insects and nematodes, are also needed.

### SUMMARY OF THE INVENTION

As described below, the present invention features compositions comprising a fatty acid (e.g., caprylic acid, ammonium nonanoate), an organic acid (e.g., vinegar, acetic acid), an essential oil or phenolic extract thereof (e.g., eugenol, thymol, carvacrol), and a surfactant (e.g., alcohol ethoxylate, sodium lauryl sulfate), and methods of using such compositions for controlling or inhibiting the growth and/or survival of undesirable plants (e.g., weeds), nematodes, and/or insects.

In an aspect, the present disclosure provides a ready-to-use herbicidal composition. The composition includes: between about 1% (vol/vol) to about 15% (vol/vol) fatty acid; between about 0.25% (vol/vol) to about 30% (vol/vol) organic acid; between about 1% (vol/vol) to about 10% (vol/vol) of an essential oil or phenolic extract thereof; and between about 0.5% (vol/vol) to about 3% (vol/vol) surfactant.

In another aspect, the present disclosure provides a concentrated herbicidal composition. The composition includes: between about 10% (vol/vol) to about 40% (vol/vol) fatty acid; between about 1% (vol/vol) to about 40% (vol/vol) organic acid; between about 1% (vol/vol) to about 15% (vol/vol) of an essential oil or phenolic extract thereof; and between about 2% (vol/vol) to about 5% (vol/vol) surfactant.

In another aspect, the present disclosure provides a ready-to-use herbicidal composition. The composition includes: caprylic acid or ammonium nonanoate; acetic acid; eugenol; and a surfactant.

In another aspect, the present disclosure provides a method of killing a plant. The method involves: contacting a plant, soil proximal to the plant, and/or an environment of the plant with the composition of any of the above aspects, or embodiments thereof, thereby killing the plant.

In another aspect, the present disclosure provides a method of reducing plant growth. The method involves: contacting a plant, soil proximal to the plant, and/or an environment of the plant with the composition of any of the above aspects, or embodiments thereof, thereby reducing growth of the plant.

In another aspect, the present disclosure provides a method of reducing the survival of a plant. The method involves: contacting a plant, a soil proximal to the plant, and/or an environment of the plant with the composition of any of the above aspects, or embodiments thereof, thereby reducing survival of the plant.

In another aspect, the present disclosure provides a method of reducing re-emergence of a plant. The method involves: contacting a plant, a soil proximal to the plant, and/or an environment of the plant with the composition of any of the above aspects, or embodiments thereof, thereby reducing re-emergence of the plant.

In another aspect, the present disclosure provides a kit for use in the method of any of the above aspects, or embodiments thereof. The kit includes the composition of any of the above aspects, or embodiments thereof and instructions for use according to the method of any of the above aspects, or embodiments thereof.

In another aspect, the present disclosure provides a concentrated composition including: between about 1% (vol/vol) to about 15% (vol/vol) fatty acid; between about 5% (vol/vol) to about 30% (vol/vol) organic acid; between about 1% (vol/vol) to about 10% (vol/vol) of an essential oil or phenolic extract thereof; and between about 0.5% (vol/vol) to about 3% (vol/vol) surfactant.

In another aspect, the present disclosure provides a concentrated insecticidal or nematocidal composition. The composition includes: caprylic acid or ammonium nonanoate; acetic acid; eugenol; and a surfactant.

In another aspect, the present disclosure provides a method of killing an insect or nematode. The method involves: contacting an insect or nematode, soil proximal to the insect or nematode, and/or an environment of the insect or nematode with the composition of any one of the above aspects, or embodiments thereof, thereby killing the insect or nematode.

In another aspect, the present disclosure provides a method of reducing the survival of an insect or nematode. The method involves: contacting an insect or nematode, soil proximal to the insect or nematode, and/or an environment of the insect or nematode with the composition of any one of the above aspects, or embodiments thereof, thereby reducing survival of the insect or nematode.

In another aspect, the present disclosure provides a kit for use in the method of any of the above aspects, or embodiments thereof, the kit comprising the composition of any of the above aspects, or embodiments thereof, and instructions for use according to the method of any of the above aspects, or embodiments thereof.

In any of the above aspects, or embodiments thereof, the fatty acid is capric, caprylic, or nonanoic acid, or ammonium nonanoate.

In any of the above aspects, or embodiments thereof, the organic acid is vinegar, formic acid, acetic acid, propionic acid, or butyric acid.

In any of the above aspects, or embodiments thereof, the surfactant is alcohol ethoxylate and/or sodium lauryl ether sulfate.

In any of the above aspects, or embodiments thereof, the essential oil is eugenol, thymol, or carvacrol.

In any of the above aspects, or embodiments thereof, the composition includes between about 1% ammonium nonanoate or caprylic acid to about 15% ammonium nonanoate or caprylic acid.

In any of the above aspects, or embodiments thereof, the composition includes between about 0.25% to about 20% acetic acid.

In any of the above aspects, or embodiments thereof, the composition includes between about 1% to about 7% eugenol.

In any of the above aspects, or embodiments thereof, the composition includes between about 0.5% to about 2% surfactant.

In any of the above aspects, or embodiments thereof, the composition includes about 1.5% caprylic acid, about 4.7% acetic acid, about 1.5% eugenol, and about 0.8% surfactant.

In any of the above aspects, or embodiments thereof, the composition includes about 3% caprylic acid, about 9.375% acetic acid, about 3% eugenol, and about 0.8% surfactant.

In any of the above aspects, or embodiments thereof, the composition includes about 6% caprylic acid, about 18.75% acetic acid, about 6% eugenol, and about 0.8% surfactant.

In any of the above aspects, or embodiments thereof, the composition includes about 9% caprylic acid, about 9.375% acetic acid, about 3% eugenol, and about 0.8% surfactant.

In any of the above aspects, or embodiments thereof, the method kills the plant within 24-hours of contact.

In any of the above aspects, or embodiments thereof, the method results in a reduction in plant growth, as compared to contacting the plant with a reference herbicidal composition.

In any of the above aspects, or embodiments thereof, the method results in a decrease in survival of the plant, as compared to contacting the plant with a reference herbicidal composition.

In any of the above aspects, or embodiments thereof, the method results in a decrease in re-emergence of the plant, as compared contacting the plant with a reference herbicidal composition.

In any of the above aspects, or embodiments thereof, growth of the plant is reduced within 24 hours of the contacting. In any of the above aspects, or embodiments thereof, growth of the plant is reduced within 1 hour of the contacting. In any of the above aspects, or embodiments thereof, growth of the plant is reduced within 30 minutes of the contacting.

In any of the above aspects, or embodiments thereof, re-emergence of the plant is reduced for at least 7 days after the contacting. In any of the above aspects, or embodiments thereof, re-emergence of the plant is reduced for at least 14 days after the contacting.

In any of the above aspects, or embodiments thereof, the plant is one or more of: amaranth weed, annual bluegrass, barnyardgrass, black medick, broadleaf fillaree, broom, bull thistle, burclover, cat's-ear, common chickweed, common groundsel, common lamb's-quarters, common mallow, corn spurry, creeping buttercup, curled dock, dandelion, English daisy, false dandelion, fiddleneck, fleabane, foxtail fescue, geranium species, horsetail, kudzu, large crabgrass, lady's-thumb, locoweed, low cudweed, lupine, morning glory, mouse-eared chickweed, mustard species, oxalis, plantain species, poison ivy, poison oak, prickly lettuce, red clover, redroot pigweed, round leaved mallow, rush, sheep sorrel, shepherd's-purse, spiny annual sowthistle, stinkweed, white clover, wild blackberry, wild carrot, wild hyacinth, and/or willowleaf lettuce.

In any of the above aspects, or embodiments thereof, the ready-to-use insecticidal or nematocidal composition includes the composition of any of the above aspects, or embodiments thereof, diluted at a ratio of between about 1:10 to 1:1000.

In any of the above aspects, or embodiments thereof, the ready-to-use insecticidal or nematocidal composition includes the composition of any of the above aspects, or embodiments thereof, diluted at a ratio of between about 1:10 and 1:100.

In any of the above aspects, or embodiments thereof, the method kills the insect or nematode within 6 hours, 24 hours, 48 hours, or 72 hours of contact.

In any of the above aspects, or embodiments thereof, the insect is an aphid, a thrip, or a beetle. In any of the above aspects, or embodiments thereof, the insect is an aphid or a thrip. In any of the above aspects, or embodiments thereof, the insect is M. persicae or F. occidentalis.

In any of the above aspects, or embodiments thereof, the nematode is a parasitic roundworm. In any of the above aspects, or embodiments thereof, the nematode is M. incognita.

Compositions and articles defined by the invention were isolated or otherwise manufactured in connection with the examples provided below. Other features and advantages of the invention will be apparent from the detailed description, and from the claims.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them below, unless specified otherwise.

By “agent” is meant any small molecule chemical compound. The small molecule chemical compound can be an organic acid (e.g., lactic acid and/or acetic acid).

By “agricultural field” is meant an area of land under cultivation or to be used for cultivating crops.

By “alteration” is meant a change (increase or decrease). In embodiments, the alteration is in a property of a plant, such as growth rate or survival rate. As used herein, an alteration includes a 10% change in growth or survival rates, preferably a 25% change, more preferably a 40% change, and most preferably a 50% or greater change.

By “carrier” is meant an inactive substance. In embodiments, the substance facilitates the application of a composition to a plant or soil.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments. Any embodiments specified as “comprising” a particular component(s) or element(s) are also contemplated as “consisting of” or “consisting essentially of” the particular component(s) or element(s) in some embodiments.

By “concentrate” is meant a composition containing a high concentration of components that is intended to be diluted. A concentrate can be referred to as 2×, 3×, 4×, 5×, etc. depending on how many-fold the concentrate must be diluted using a solvent (e.g., water) to obtain a target, or working, concentration of the composition components. The concentrate can be a 1.5×, 2×, 3×, 4×, 5×, 10×, 15×, 20×, 25×, 50×, 75×, 100×, 150×, 200×, 250×, 300×, 500×, 750×, or 1,000× concentrate.

“Detect” refers to identifying the presence, absence or amount of the analyte to be detected.

The term “insect” includes all organisms of the Arthropoda phylum, as well as their cells, tissues, and products. Accordingly, the term insect includes eggs, and various adult and immature stages of such organisms, and the like. In embodiments, the insect is a member of subphylum Hexapoda and/or class Insecta. In embodiments, the insect is an undesirable insect (e.g., a pest). In embodiments, the insect is an aphid (e.g., M. persicae), a thrip (e.g., F. occidentalis), or a beetle (e.g., T. molitor).

The term “nematode” includes all organisms of the Nematoda phylum, as well as their cells, tissues, and products. Accordingly, the term nematode includes eggs, and various adult and immature stages of such organisms, and the like. In embodiments, the nematode is an undesirable nematode (e.g., a pest). In some embodiments, the nematode is a parasitic roundworm (e.g., M. incognita). In some embodiments, the nematode is a plant parasite.

As used herein, “obtaining” as in “obtaining an agent” includes synthesizing, purchasing, or otherwise acquiring the agent.

The term “plant” includes all organisms of the plant kingdom, as well as their cells, tissues, and products. Accordingly, the term plant includes seeds, leaves, stems, roots, fruit, and the like. In embodiments, a plant may be a desirable plant under cultivation or an undesirable plant (e.g., a weed).

By “ready-to-use” is meant a formulation that is ready to be applied to a target without dilution of the formulation. In some embodiments, a ready-to-use formulation of the compositions of the present disclosure may be applied, as is, to an undesirable plant, nematode, and/or insect without dilution.

By “reduces” is meant a negative alteration of at least 5%, 10%, 25%, 50%, 75%, or 100%.

By “reference” is meant a standard or control condition. In one embodiment, a reference is a plant, soil, or other medium that comprises an undesirable plant, but that is not contacted with a composition of the present disclosure. In some embodiments, a reference is a plant soil, or other medium that comprises an undesirable plant, and has been contacted with a commercially available herbicide, but that is not contacted with a composition of the present disclosure. In some embodiments, a reference is a commercially available herbicide, particular in comparison to a composition of the present disclosure.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

As used herein, “soil” refers to a composition that functions to provide structural support to plants and functions as a source of water and nutrients for the plants. A soil can contain a mixture of inorganic (e.g., sand, silt, clay, gravel) and organic materials. The soil can contain particles greater than 2 mm in diameter (gravel), particles from about 0.2 mm in diameter to about 2 mm in diameter (coarse sand), particles from about 0.02 mm in diameter to about 0.2 mm in diameter (fine sand), particles from about 0.002 mm in diameter to about 0.02 mm in diameter (silt), particles of less than 0.002 mm in diameter (clay) or various combinations thereof.

Unless specifically stated or obvious from context, as used herein, the term “or” is understood to be inclusive. Unless specifically stated or obvious from context, as used herein, the terms “a”, “an”, and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

### BRIEF DESCRIPTION OF THE DRAWINGS

FIGS. 1A-1F provide photographs showing pre- and post-treatment weeds treated with TBH-003. In each of FIGS. 1A-1F, the left panel is a pre-treatment photograph, and the right panel is a post-treatment photograph.

FIGS. 2A-2F provide photographs showing pre- and post-treatment weeds treated with TBH-003. In each of FIGS. 2A-2F, the left panel is a pre-treatment photograph and the right panel is a post-treatment photograph. Pre-treatment and post-treatment times (if on the same day) or dates are provided above each panel.

FIGS. 3A-3F provide bar graphs showing the herbicidal effects of various formulations of TBH-003. FIG. 3A shows the herbicidal effects of half rate, full rate, and double rate TBH-003 on dandelion weeds, as compared to an untreated plot, at 0, 1, 7, and 14 days after application. FIG. 3B shows the herbicidal effects of half rate, full rate, and double rate TBH-003 on amaranth weeds, as compared to an untreated plot, at 0, 1, 7, and 14 days after application. FIG. 3C shows the herbicidal effects of half rate, full rate, and double rate TBH-003 on Brassica kaber, as compared to an untreated plot, at 0, 1, 7, and 14 days after application. FIG. 3D shows the herbicidal effects of half rate, full rate, and double rate TBH-003 on other minor weeds, as compared to an untreated plot, at 0, 1, 7, and 14 days after application. FIG. 3E shows the overall percent control of the weed population of half rate, full rate, and double rate TBH-003, as compared to an untreated plot, at 1, 7, and 14 days after application. FIG. 3F shows the percent re-emergence of the overall weed population after application of half rate, full rate, and double rate TBH-003, as compared to an untreated plot, at 7 and 14 days after application. In each of FIGS. 3A-3F, the bars in the graphs are ordered as follows, from left to right: untreated; half rate TBH-003; full rate TBH-003; and double rate TBH-003.

FIGS. 4A-4B provide photographs showing furrows treated with TBH-003. FIG. 4A shows furrows 7 days after treatment, from left to right: untreated negative control; TBH-003 half rate; TBH-003 full rate; and TBH-003 double rate. FIG. 4B shows furrows 14 days after treatment, from left to right: untreated negative control; TBH-003 half rate; TBH-003 full rate; and TBH-003 double rate.

FIGS. 5A-5E provide bar graphs showing comparative herbicidal effect between two different formulations of TBH-003 as compared to two commercially available herbicides. FIG. 5A shows the herbicidal effects of Suppress®, AXXE®, high cap TBH-003, and double rate TBH-003 on dandelion weeds, as compared to an untreated plot, at 0, 1, 7, and 14 days after application. FIG. 5B shows the herbicidal effects of Suppress®, AXXE®, high cap TBH-003, and double rate TBH-003 on malva weeds, as compared to an untreated plot, at 0, 1, 7, and 14 days after application. FIG. 5C shows the herbicidal effects of Suppress®, AXXE®, high cap TBH-003, and double rate TBH-003 on other minor weeds, as compared to an untreated plot, at 0, 1, 7, and 14 days after application. FIG. 5D shows the overall percent control of weeds of Suppress®, AXXE®, high cap TBH-003, and double rate TBH-003, as compared to an untreated plot, at 0, 1, 7, and 14 days after application. FIG. 5E shows the percent resurgence of weed populations after treatment with Suppress®, AXXE®, high cap TBH-003, and double rate TBH-003, as compared to an untreated plot, at 0, 1, 7, and 14 days after application. In each of FIGS. 5A-5E, the bars in the graphs are ordered as follows, from left to right: untreated; Suppress®; AXXE®; High cap TBH-003; and double rate TBH-003.

FIGS. 6A-6C provide photographs showing furrows treated with each of the test conditions provided in FIGS. 5A-5E. FIG. 6A shows furrows 1 day after treatment, from left to right: untreated negative control; Suppress®; AXXE®; High cap TBH-003; and double rate TBH-003. FIG. 6B shows furrows 7 days after treatment, from left to right: untreated negative control; Suppress®; AXXE®; High cap TBH-003; and double rate TBH-003. FIG. 6C shows furrows 14 days after treatment, from left to right: untreated negative control; Suppress®; AXXE®; High cap TBH-003; and double rate TBH-003.

### DETAILED DESCRIPTION OF THE INVENTION

The invention features compositions and methods that are useful for controlling or inhibiting growth and/or survival of undesirable plants (e.g., weeds).

The present invention is based, at least in part, on the discovery that herbicidal compositions comprising fatty and organic acids, an essential oil or phenolic extract thereof (e.g., eugenol, thymol, carvacrol), and a surfactant are surprisingly effective in reducing the growth and/or survival of undesirable plants. In particular, herbicidal compositions disclosed herein not only provide rapid onset control of undesirable plants, but also provide long-term suppression of reemergence of undesirable plant growth. Without intending to be bound by theory, the particular combination of an essential oil or phenolic extract thereof (e.g., eugenol, thymol, carvacrol) and a surfactant is believed to significantly increase the porosity of the surface of the plant, thereby rendering the herbicidal compositions disclosed herein surprisingly effective.

### Compositions

The invention provides compositions used for controlling or inhibiting the growth and/or survival of an undesirable plant (e.g., weed). In embodiments, the compositions comprise a fatty acid (e.g., caprylic (octanoic) acid, pelargonic (nonanoic) acid, ammonium nonanoate, capric (decanoic) acid, undecylic (undecanoic) acid, and/or lauric (dodecanoic) acid), an organic acid (e.g., vinegar, acetic acid), an essential oil or phenolic extract thereof (e.g., eugenol, thymol, carvacrol), and a surfactant.

Fatty acids useful for compositions of the present disclosure may be any form of fatty acid known in the art for use in an herbicidal formulation. In some embodiments, the fatty acid is a saturated fatty acid. In some embodiments, the fatty acid is an unsaturated fatty acid. In some embodiments, the fatty acid comprises the formula CH₃(CH₂)ₙCOOH. In some embodiments, the fatty acid comprises a molecule having 7, 8, 9, 10, 11, 12, 13, 14, 15, 16, 17, 18, 19, 20, or more carbon atoms in a carbon backbone of the molecule. In some embodiments, the fatty acid is or more of: caprylic (octanoic) acid, pelargonic (nonanoic) acid, ammonium nonanoate, capric (decanoic) acid, undecylic (undecanoic) acid, and/or lauric (dodecanoic) acid. Exemplary structures of fatty acids which may be used in the compositions of the present disclosure may be found below:

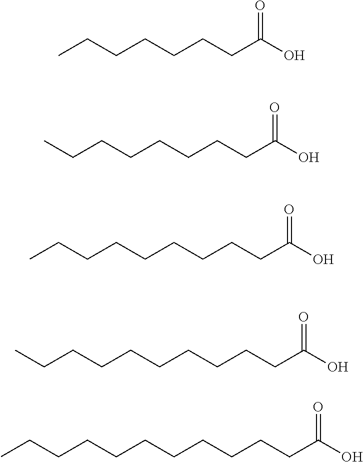

In some embodiments, a “ready-to-use” formulation of the composition, which is ready for application to a plant, a soil, or a plant environment without dilution, comprises about 1% (vol/vol), 1.5% (vol/vol), 2% (vol/vol), 2.5% (vol/vol), 3% (vol/vol), 4% (vol/vol), 5% (vol/vol), 6% (vol/vol), 7% (vol/vol), 8% (vol/vol), 9% (vol/vol), 10% (vol/vol), 11% (vol/vol), 12% (vol/vol), 13% (vol/vol), 14% (vol/vol), 15% (vol/vol), 16% (vol/vol), 17% (vol/vol), 18% (vol/vol), 19% (vol/vol), or 20% (vol/vol) fatty acid. Fatty acids of the compositions of the present disclosure may also be present in the form of salts or esters thereof. Exemplary salts of a fatty acid include an ammonium salt, a potassium salt, a choline salt, and a sodium salt. Exemplary esters of a fatty acid include 2-ethyhexyl, 2-butoxy, and butoxyethyl.

Organic acids useful for compositions of the present disclosure may be any form of organic acid known in the art for use in an herbicidal formulation. In some embodiments, the organic acid is vinegar. In another embodiment, the organic acid is a carboxylic acid. In some embodiments, the organic acid comprises the formula RCOOH or H(CH₂)ₙCOOH. In some embodiments, the organic acid is one or more of formic acid, acetic acid, propionic acid, and/or butyric (butanoic) acid. Exemplary structures of organic acids which may be used in the compositions of the present disclosure may be found below:

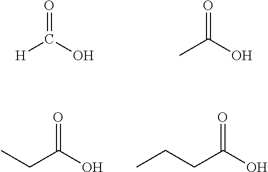

In some embodiments, a “ready-to-use” formulation of the composition, which is ready for application to a plant, a soil, or a plant environment without dilution, comprises about 0.25% (vol/vol), 0.5% (vol/vol), 075% (vol/vol), 1% (vol/vol), 2% (vol/vol), 3% (vol/vol), 4% (vol/vol), 5% (vol/vol), 6% (vol/vol), 7% (vol/vol), 8% (vol/vol), 9% (vol/vol), 10% (vol/vol), 11% (vol/vol), 12% (vol/vol), 13% (vol/vol), 14% (vol/vol), 15% (vol/vol), 16% (vol/vol), 17% (vol/vol), 18% (vol/vol), 19% (vol/vol), 20% (vol/vol), 21% (vol/vol), 22% (vol/vol), 23% (vol/vol), 24% (vol/vol), 25% (vol/vol), 26% (vol/vol), 27% (vol/vol), 28% (vol/vol), 29% (vol/vol), 30% (vol/vol), 31% (vol/vol), 32% (vol/vol), 33% (vol/vol), 34% (vol/vol), or 35% (vol/vol) organic acid.

Compositions of the present disclosure include one or more essential oils. In some embodiments, the essential oil may be a phenolic extract thereof. In some embodiments, the essential oil is eugenol, thymol, or carvacrol. In some embodiments, the essential oil is an essential oil containing significant amounts of phenols.

Carvacrol, which may also be known as 2-Methyl-5-(propan-2-yl)phenol, is an monoterpenoid phenol, and is an essential oil found in, for example, oregano, thyme, pepperwort, and wild bergamot. An exemplary chemical structure of carvacrol is found below:

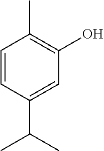

In some embodiments, a “ready-to-use” formulation of the composition, which is ready for application to a plant, a soil, or a plant environment without dilution, comprises about 1% (vol/vol), 2% (vol/vol), 3% (vol/vol), 4% (vol/vol), 5% (vol/vol), 6% (vol/vol), 7% (vol/vol), 8% (vol/vol), 9% (vol/vol), 10% (vol/vol), 11% (vol/vol), 12% (vol/vol), 13% (vol/vol), 14% (vol/vol), or 15% (vol/vol) carvacrol.

Eugenol, which may also be known as 2-Methoxy-4-(prop-2-en-1-yl)phenol, is an allyl chain-substituted guaiacol, and is an essential oil found in, for example, clove, nutmeg, cinnamon, basil, and bay leaf. An exemplary chemical structure of eugenol is found below:

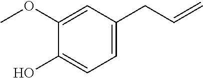

In some embodiments, a “ready-to-use” formulation of the composition, which is ready for application to a plant, a soil, or a plant environment without dilution, comprises about 1% (vol/vol), 2% (vol/vol), 3% (vol/vol), 4% (vol/vol), 5% (vol/vol), 6% (vol/vol), 7% (vol/vol), 8% (vol/vol), 9% (vol/vol), 10% (vol/vol), 110% (vol/vol), 12% (vol/vol), 13% (vol/vol), 14% (vol/vol), or 15% (vol/vol) eugenol.

Thymol, which may also be known as 5-Methyl-2-(propan-2-yl)phenol, is an monoterpenoid phenol, and is an essential oil found in, for example, thyme and ajwain. An exemplary chemical structure of thymol is found below:

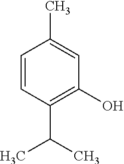

In some embodiments, a “ready-to-use” formulation of the composition, which is ready for application to a plant, a soil, or a plant environment without dilution, comprises about 1% (vol/vol), 2% (vol/vol), 3% (vol/vol), 4% (vol/vol), 5% (vol/vol), 6% (vol/vol), 7% (vol/vol), 8% (vol/vol), 9% (vol/vol), 10% (vol/vol), 11% (vol/vol), 12% (vol/vol), 13% (vol/vol), 14% (vol/vol), or 15% (vol/vol) thymol.

Surfactants useful for compositions of the present disclosure may be any form of surfactant known in the art known as suitable for use with fatty acids and/or organic acids. Exemplary surfactants for use with fatty acids include one or more of: organosilicones, methylated seed oil, and ethylated seed oil, alkylpolyoxyethylene ethers, alkylarylalolates alkylphenol ethoxylate and alcohol alkoxylate surfactants, fatty acid and fatty amine ethoxylates, anionic surfactants such as sulfosuccinates, sulfonates, and phosphate esters, polyethylene glycol (PEG) fatty acid esters and alkyl napthalene sulfonates, tristyrylphenol, castor oil and fatty amine ethoxylates and products such as sorbitan and ethoxylated sorbitan esters, ethoxylated alcohols and alkylphenols, ethoxylated vegetable oils, alkyl, glycol and glycerol esters. Also, to be included are natural emulsifiers such as lecithin. In some embodiments, the surfactant includes one or more of: alcohol ethoxylate, glycerol, alkylbenzenesulfonate, ammonium lauryl sulfate, sodium lauryl sulfate (SLS), sodium dodecyl sulfate (SDS), sodium laureth sulfate, sodium lauryl ether sulfate (SLES), sodium myreth sulfate, dioctyl sodium sulfosuccinate, perfluorooctane sulfonate, perfluorobutanesulfonate, alkyl-aryl ether phosphates, alkyl ether phosphates, sodium stearate, sodium lauroyl sarcosinate, perfluorononanoate, and perfluorooctanoate. In some embodiments, a “ready-to-use” formulation of the composition, which is ready for application to a plant, a soil, or a plant environment without dilution, comprises about 0.5% (vol/vol), 0.6% (vol/vol), 0.7% (vol/vol), 0.8% (vol/vol), 0.9% (vol/vol), 1% (vol/vol), 1.1% (vol/vol), 1.2% (vol/vol), 1.3% (vol/vol), 1.4% (vol/vol), 1.5% (vol/vol), 1.6% (vol/vol), 1.7% (vol/vol), 1.8% (vol/vol), 1.9% (vol/vol), 2% (vol/vol), 3% (vol/vol), 4% (vol/vol), 5% (vol/vol), 6% (vol/vol), 7% (vol/vol), 8% (vol/vol), 9% (vol/vol), or 10% (vol/vol) surfactant.

In some embodiments, the surfactant comprises an emulsifier, a dispersing agent or a wetting agent of ionic or non-ionic type or a mixture of such surfactants. Further non-limiting examples of surfactants include polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols, and derivatives of the above compounds containing sulphate, sulphonate and phosphate functions.

The compositions may be prepared by mixing a fatty acid, an organic acid, an essential oil or phenolic extract thereof (e.g., eugenol, thymol, carvacrol), and a surfactant, with agriculturally acceptable carriers and/or additives. Non-limiting examples of carriers and/or additives include extenders, solvents, diluents, dyes, wetters, dispersants, emulsifiers, antifoaming agents, nutrients, preservatives, secondary thickeners, adhesives, and/or water. Formulations of the present invention may include agriculturally acceptable carriers, which are inert formulation ingredients added to formulations to improve recovery, efficacy, or physical properties and/or to aid in packaging and administration. Carriers may include anti-caking agents, anti-oxidation agents, bulking agents, and/or protectants. Examples of useful carriers include polysaccharides (starches, maltodextrins, methylcelluloses, proteins, such as whey protein, peptides, gums), sugars (lactose, trehalose, sucrose), lipids (lecithin, vegetable oils, mineral oils), salts (sodium chloride, calcium carbonate, sodium citrate), silicates (clays, amorphous silica, fumed/precipitated silicas, silicate salts), waxes, oils, and alcohols.

Further non-limiting examples of carriers include a natural or synthetic, organic or inorganic substance which is mixed or combined with a fatty acid, an organic acid, an essential oil or phenolic extract thereof (e.g., eugenol, thymol, carvacrol), and a surfactant for better applicability, in particular for application to plants or plant parts, soils, or seeds. The support or carrier, which may be solid or liquid, is generally inert and should be suitable for use in agriculture. Suitable solid or liquid carriers/supports include for example ammonium salts and natural ground minerals, such as kaolins, clays, talc, chalk, quartz, attapulgite, montmorillonite or diatomaceous earth, and ground synthetic minerals, such as finely divided silica, alumina and natural or synthetic silicates, resins, waxes, solid fertilizers, water, alcohols, especially butanol, organic solvents, mineral oils and vegetable oils, and also derivatives and various combinations thereof. It is also possible to use mixtures of such supports or carriers. Solid supports/carriers suitable for granules are, for example, crushed and fractionated natural minerals, such as calcite, marble, pumice, sepiolite, dolomite, and also synthetic granules of inorganic and organic meals and also granules of organic material, such as sawdust, coconut shells, maize cobs and tobacco stalks. Suitable liquefied gaseous extenders or carriers are liquids which are gaseous at ambient temperature and under atmospheric pressure, for example aerosol propellants, such as butane, propane, nitrogen and carbon dioxide. Tackifiers, such as carboxymethylcellulose and natural and synthetic polymers in the form of powders, granules and latices, such as gum arabic, polyvinyl alcohol, polyvinyl acetate, or else natural phospholipids, such as cephalins and lecithins and synthetic phospholipids can be used in the formulations. Other possible additives are mineral and vegetable oils and waxes, optionally modified. If the extender used is water, it is also possible for example, to use organic solvents as auxiliary solvents. Suitable liquid solvents are essentially: aromatic compounds, such as xylene, toluene or alkylnaphthalenes, chlorinated aromatic compounds or chlorinated aliphatic hydrocarbons, such as chlorobenzenes, chloroethylenes or methylene chloride, aliphatic hydrocarbons, such as cyclohexane or paraffins, for example mineral oil fractions, mineral and vegetable oils, alcohols, such as butanol or glycol, and also ethers and esters thereof, ketones, such as acetone, methyl ethyl ketone, methyl isobutyl ketone or cyclohexanone, strongly polar solvents, such as dimethylformamide and dimethyl sulphoxide, and also water.

In some embodiments, the composition may include components that facilitate the application of the composition to a plant or soil. The application of a composition of the invention to soil may be performed by drenching, incorporation into soil, or by droplet application.

In some embodiments, the composition may contain a liquid diluent or solvent (e.g., water). Exemplary diluents for use in the compositions of the present disclosure include mineral oil and natural oils such as vegetable oil, coconut oil, olive oil, corn oil, canola oil, cottonseed oil, and soybean oil. The carrier may be a liquid. The carrier may improve the stability, handling, storage, shipment, or application properties of the composition.

Additional components may also be included in the compositions, as non-limiting examples, protective colloids, adhesives, nutrients, thickeners, thixotropic agents, penetration agents, stabilizers, sequestering agents.

In some embodiments, the compositions comprise colorants, such as inorganic pigments (e.g., iron oxide, titanium oxide, and Prussian blue), and organic dyes (e.g., alizarin dyes, and azo dyes) and metal phthalocyanine dyes.

In any of the embodiments of the compositions provided herein, formulations may be developed as adjuvants to be applied concurrently with existing commercial products to enable and/or enhance their effectiveness.

In any of the embodiments of the compositions provided herein, the compositions may be non-toxic and include component parts that exhibit no toxic effects to humans, to the soil or desirable plants in the nearby plant environment, or to the environment, including no toxicity to groundwater, flora, or fauna.

These compositions include not only compositions which are ready to be applied to a plant, seed, or soil to be treated by means of a suitable device, such as a spraying device, but also concentrated commercial compositions (i.e., concentrates) which must be diluted before they are applied to a soil or plant. In some embodiments, a concentrate of the present disclosure may include: between about 25% (vol/vol) to about 50% (vol/vol) fatty acid; between about 30% (vol/vol) to about 70% (vol/vol) organic acid; between about 10% (vol/vol) to about 25% (vol/vol) an essential oil or phenolic extract thereof (e.g., eugenol, thymol, carvacrol); and between about 2% to about 15% surfactant.

### Methods of Delivery

In some embodiments, the present disclosure provides a method of controlling plant growth involving contacting an undesirable plant (e.g., weed), a plant part, a soil, and/or a plant environment with the compositions described herein. In some embodiments, the method comprises contacting the undesirable plant with a composition comprising or consisting essentially of a fatty acid, an organic acid, an essential oil or phenolic extract thereof (e.g., eugenol, thymol, carvacrol), and a surfactant.

In some embodiments, the present disclosure provides a method of inhibiting plant growth involving contacting an undesirable plant (e.g., weed), a plant part, a soil, and/or a plant environment with the compositions described herein. In some embodiments, the method comprises contacting the undesirable plant with a composition comprising or consisting essentially of a fatty acid, an organic acid, an essential oil or phenolic extract thereof (e.g., eugenol, thymol, carvacrol), and a surfactant.

In some embodiments, the present disclosure provides a method of killing and/or eradicating an undesirable plant involving contacting an undesirable plant (e.g., weed), a plant part, a soil, and/or a plant environment with the compositions described herein. In some embodiments, the method comprises contacting the undesirable plant with a composition comprising or consisting essentially of a fatty acid, an organic acid, an essential oil or phenolic extract thereof (e.g., eugenol, thymol, carvacrol), and a surfactant.

In some embodiments, the present disclosure provides a method of inhibiting or controlling the survival of an undesirable plant involving contacting an undesirable plant (e.g., weed), a plant part, a soil, and/or a plant environment with the compositions described herein. In some embodiments, the method comprises contacting the undesirable plant with a composition comprising or consisting essentially of a fatty acid, an organic acid, an essential oil or phenolic extract thereof (e.g., eugenol, thymol, carvacrol), and a surfactant.

In some embodiments, the methods involve applying the composition to an undesirable plant or to the soil in which the plant is growing. Applying the composition may be achieved by various means, including, for example, by sprinklering, spraying, drenching, soaking, watering, crop-dusting, misting, high-pressure liquid injection, or otherwise applying the composition to the plants or surrounding soil. The composition can be applied using an irrigation system. In some embodiments, the composition is applied to the plant itself, such as to the leaves, stem, trunk, stalk, flowers, branches, fruits, roots, shoots, buds, rhizome, seeds, or other portions of the plant, or it is applied to the soil in which or around which the plant is being cultivated.

In embodiments the composition is applied to a soil and/or plant multiple times. In embodiments, the soil and/or plant is contacted with the composition about or at least about 1, 2, 3, 4, 5, 6, 7, 8, 9, 10, 11, 12, 13, 14, 15, 16, 17, 18, 19, or 20 times. In various embodiments, each contacting is spaced from the previous contacting by a time interval individually ranging from about or at least about 12 hours, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days 24 days, or 25 days.

It will be appreciated that an effective amount of the compositions disclosed herein may be adjusted based on the undesirable plant to be contacted, the desired application outcome, or any additional additives may be included in the composition. In some embodiments, the effective amount is an amount of about 5 gallons/acre to about 100 gallons/acre. In some embodiments, the effective amount is an amount of about 5 gallons/acre, 10 gallons/acre, 15 gallons/acre, 20 gallons/acre, 25 gallons/acre, 30 gallons/acre, 35 gallons/acre, 40 gallons/acre, 45 gallons/acre, 50 gallons/acre, 55 gallons/acre, 60 gallons/acre, 65 gallons/acre, 70 gallons/acre, 75 gallons/acre, 80 gallons/acre, 85 gallons/acre, 90 gallons/acre, 95 gallons/acre, or 100 gallons/acre of the compositions disclosed herein.

In some embodiments, the methods of application disclosed herein result in significantly higher herbicidal effect as compared to currently available herbicidal formulations and their associated application methods. In some embodiments, the herbicidal effect may be characterized by one or more of: an increase in control or inhibition of undesirable plant (e.g., weed) growth, an increase in prevention of reemergence of undesirable plant growth, an increase in levels of undesirable plant death (i.e., a decrease in survival of undesirable plants), and/or an increase in the rate of any of the preceding (i.e., faster herbicidal effect). Exemplary reference herbicidal formulations include those utilizing capric and caprylic acid (e.g., Suppress®) those using ammonium nonanoate (e.g., AXXE®), for example.

In some embodiments, the higher herbicidal effect is about a 25%, 30%, 35%, 40%, 45%, 50%, 55%, 60%, 65%, 70%, 75%, 80%, 85%, 90%, or 95% increase in herbicidal effect. In some embodiments, the higher herbicidal effect is about a 2-times, 3-times, 4-times, 5-times, 6-times, 7-times, 8-times, 9-times, 10-times, or more increase in herbicidal effect.

Methods of the present disclosure may be used with any undesired plant, including weeds. In some embodiments, a plant or plant part thereof for which a composition of the present disclosure, or method of use thereof may be used may be an angiosperm (e.g., a dicot plant or a monocot plant), gymnosperm, algae, bryophyte (e.g., a moss), and/or fern and/or fern ally (e.g., a pteridophyte). Exemplary undesirable plants for which a composition of the present disclosure, or method of use thereof may be used include: amaranth weed, annual bluegrass, barnyardgrass, black medick, broadleaf fillaree, broom, bull thistle, burclover, cat's-ear, common chickweed, common groundsel, common lamb's-quarters, common mallow, corn spurry, creeping buttercup, curled dock, dandelion, English daisy, false dandelion, fiddleneck, fleabane, foxtail fescue, geranium species, horsetail, kudzu, large crabgrass, lady's-thumb, locoweed, low cudweed, lupine, morning glory, mouse-eared chickweed, mustard species, oxalis, plantain species, poison ivy, poison oak, prickly lettuce, red clover, redroot pigweed, round leaved mallow, rush, sheep sorrel, shepherd's-purse, spiny annual sowthistle, stinkweed, white clover, wild blackberry, wild carrot, wild hyacinth, and/or willowleaf lettuce. In some embodiments, a plant or part thereof that is controlled by the herbicidal mixtures of the invention can include turfgrasses, which can include, but is not limited to, Kentucky bluegrass, perennial ryegrass, bentgrass, tall fescue, fine fescue, Bermuda grass, St. Augustine grass, zoysia grass, bahaigrass, buffalograss, carpetgrass, centipede grass, kikuyu grass, seashore paspalam, or any combination thereof.

In some embodiments, the present disclosure provides a method of controlling insect or nematode growth involving contacting an undesirable insect or nematode, a part thereof, a soil, and/or an insect or nematode environment with the compositions described herein. In some embodiments, the method comprises contacting the undesirable insect or nematode with a composition comprising or consisting essentially of a fatty acid, an organic acid, an essential oil or phenolic extract thereof (e.g., eugenol, thymol, carvacrol), and a surfactant.

In some embodiments, the present disclosure provides a method of inhibiting insect or nematode growth involving contacting an undesirable insect or nematode, a part thereof, a soil, and/or an insect or nematode environment with the compositions described herein. In some embodiments, the method comprises contacting the undesirable insect or nematode with a composition comprising or consisting essentially of a fatty acid, an organic acid, an essential oil or phenolic extract thereof (e.g., eugenol, thymol, carvacrol), and a surfactant.

In some embodiments, the present disclosure provides a method of killing and/or eradicating an undesirable insect or nematode involving contacting an undesirable insect or nematode, a part thereof, a soil, and/or an insect or nematode environment with the compositions described herein. In some embodiments, the method comprises contacting the undesirable insect or nematode with a composition comprising or consisting essentially of a fatty acid, an organic acid, an essential oil or phenolic extract thereof (e.g., eugenol, thymol, carvacrol), and a surfactant.

In some embodiments, the present disclosure provides a method of inhibiting or controlling the survival of an undesirable insect or nematode involving contacting an undesirable insect or nematode, a part thereof, a soil, and/or an insect or nematode environment with the compositions described herein. In some embodiments, the method comprises contacting the undesirable insect or nematode with a composition comprising or consisting essentially of a fatty acid, an organic acid, an essential oil or phenolic extract thereof (e.g., eugenol, thymol, carvacrol), and a surfactant.

In some embodiments, the methods involve applying the composition to an undesirable insect or nematode or to an environment or site proximal to the undesirable insect or nematode. Applying the composition may be achieved by various means, including, for example, by sprinklering, spraying, drenching, soaking, watering, crop-dusting, misting, high-pressure liquid injection, or otherwise applying the composition to the insect or nematode or surrounding soil. The composition can be applied using an irrigation system. In some embodiments, the composition is applied to the insect or nematode itself, or it is applied to an environment surrounding the insect or nematode (e.g., a soil or a plant part).

In embodiments the composition is applied to a insect or nematode and/or an environment thereof multiple times. In embodiments, the insect or nematode and/or an environment thereof is contacted with the composition about or at least about 1, 2, 3, 4, 5, 6, 7, 8, 9, 10, 11, 12, 13, 14, 15, 16, 17, 18, 19, or 20 times. In various embodiments, each contacting is spaced from the previous contacting by a time interval individually ranging from about or at least about 12 hours, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days 24 days, or 25 days.

It will be appreciated that an effective amount of the compositions disclosed herein may be adjusted based on the undesirable insect or nematode to be contacted, the desired application outcome, or any additional additives may be included in the composition. In some embodiments, the effective amount is an amount of about 5 gallons/acre to about 100 gallons/acre. In some embodiments, the effective amount is an amount of about 5 gallons/acre, 10 gallons/acre, 15 gallons/acre, 20 gallons/acre, 25 gallons/acre, 30 gallons/acre, 35 gallons/acre, 40 gallons/acre, 45 gallons/acre, 50 gallons/acre, 55 gallons/acre, 60 gallons/acre, 65 gallons/acre, 70 gallons/acre, 75 gallons/acre, 80 gallons/acre, 85 gallons/acre, 90 gallons/acre, 95 gallons/acre, or 100 gallons/acre of the compositions disclosed herein.

Methods of the present disclosure may be used with any insect or nematode. In some embodiments, an insect or nematode for which a composition of the present disclosure, or method of use thereof may be used may be an aphid, a thrip, or a beetle. Exemplary insects insect for which a composition of the present disclosure, or method of use thereof may be used include, without limitation, M. persicae and F. occidentalis. Exemplary nematodes for which a composition of the present disclosure, or method of use thereof may be used include, without limitation, parasitic roundworms such as M. incognita. Also contemplated are any combination of the aforementioned insects and nematodes.

### Kits

This disclosure provides a kit that includes a composition comprising a fatty acid, an organic acid, an essential oil or phenolic extract thereof (e.g., eugenol, thymol, carvacrol), and a surfactant. In some embodiments, the kit comprises an applicator. In some embodiments, the kit is a ready-to-use kit, wherein the composition included in the kit is ready to use by the user without further alterations. In some embodiments, the composition is provided in the kit in a container for application to a plant or soil. In some embodiments, the container is a spray applicator containing the composition. In some embodiments, the composition is a concentrated liquid, or a solid. In such embodiments, the composition may be added to a liquid, such as water, to dilute the concentrated liquid or to dissolve the solid composition. In some embodiments, the composition is a diluted composition. In some embodiments, the spray applicator is configured for industrial, commercial, home-gardener, or recreational purposes. In some embodiments, the kit includes a dispensing apparatus, such as a nozzle, a valve, a sprayer, or any other apparatus capable of dispensing the compositions described herein.

If desired, the kit further contains instructions for using the compositions and/or administering the compositions. In particular embodiments, the instructions include at least one of the following: description of the components of the composition; application amounts and techniques; precautions; warnings; counter-indications; and/or references. The instructions may be printed directly on components of the kit or provided as a separate sheet, pamphlet, card, or folder supplied with the kit. The instructions can be provided in digital form on a portable data storage medium (e.g., a compact disk or USB drive) or stored remotely on a server that can be accessed remotely.

The practice of the present invention employs, unless otherwise indicated, conventional techniques of molecular biology (including recombinant techniques), microbiology, cell biology, biochemistry and immunology, which are well within the purview of the skilled artisan. Such techniques are explained fully in the literature, such as, “Molecular Cloning: A Laboratory Manual”, second edition (Sambrook, 1989); “Oligonucleotide Synthesis” (Gait, 1984); “Animal Cell Culture” (Freshney, 1987); “Methods in Enzymology” “Handbook of Experimental Immunology” (Weir, 1996); “Gene Transfer Vectors for Mammalian Cells” (Miller and Calos, 1987); “Current Protocols in Molecular Biology” (Ausubel, 1987); “PCR: The Polymerase Chain Reaction”, (Mullis, 1994); “Current Protocols in Immunology” (Coligan, 1991). These techniques are applicable to the production of the polynucleotides and polypeptides of the invention, and, as such, may be considered in making and practicing the invention. Particularly useful techniques for particular embodiments will be discussed in the sections that follow.

The following examples are put forth so as to provide those of ordinary skill in the art with a complete disclosure and description of how to make and use the assay, screening, and therapeutic methods of the invention, and are not intended to limit the scope of what the inventors regard as their invention.

### EXAMPLES

### Example 1: Ready-to-use Herbicidal Formulation

Ready-to-use herbicidal compositions are prepared containing between 1-15% (vol/vol) capric, caprylic, ammonium nonanoate, or nonanoic acid; 0.25-20% (vol/vol) formic acid, acetic acid, propionic acid, or butyric acid; 0.5-2% (vol/vol) eugenol, thymol, or carvacrol; and 0.5-1% (vol/vol) alcohol ethoxylate and/or sodium lauryl ether sulfate and water.

### Example 2: Concentrated Herbicidal Formulation

Concentrated herbicidal compositions are prepared containing 30% capric, caprylic, ammonium nonanoate, or nonanoic acid; 1-30% formic acid, acetic acid, propionic acid, or butyric acid; 5% (vol/vol) eugenol, thymol, or carvacrol; and 2% (vol/vol) alcohol ethoxylate or sodium lauryl ether sulfate and water.

### Example 3: Compositions of the Disclosure Kill a Variety of Weeds

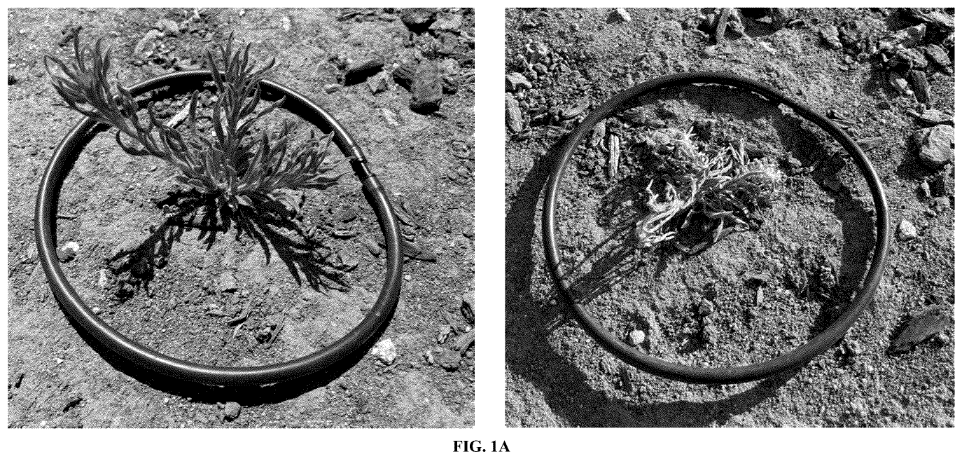

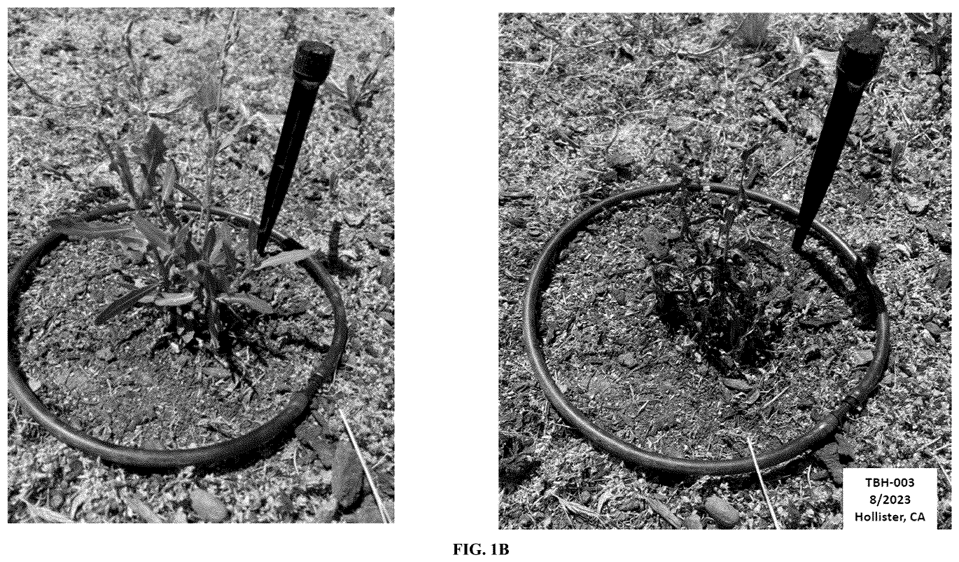

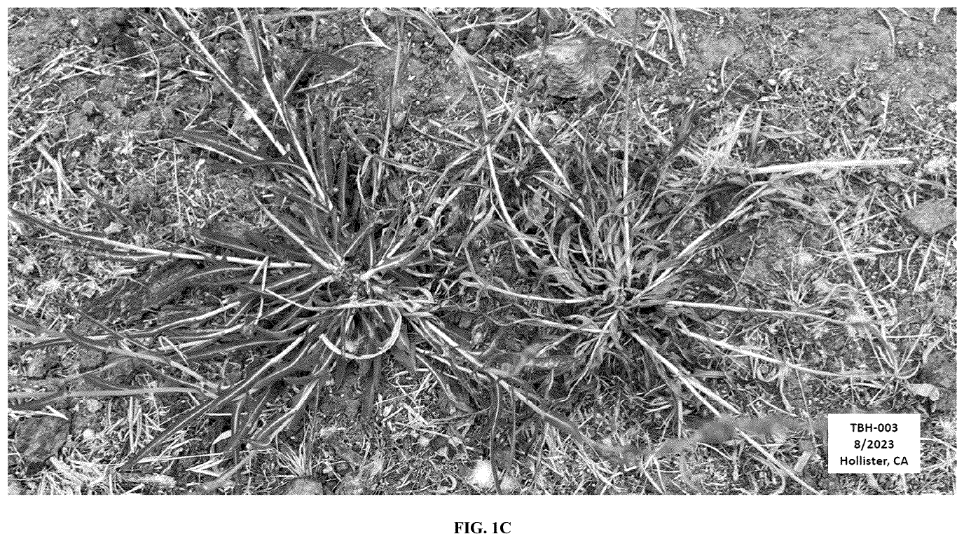

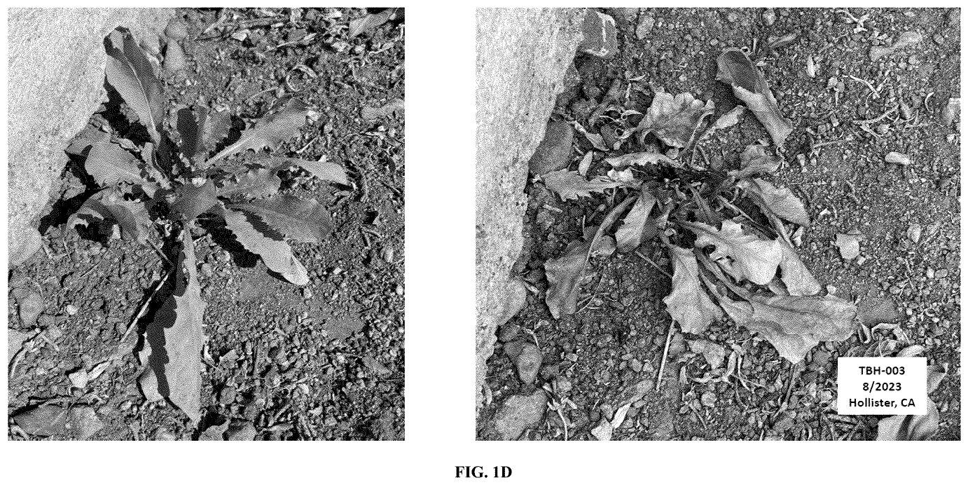

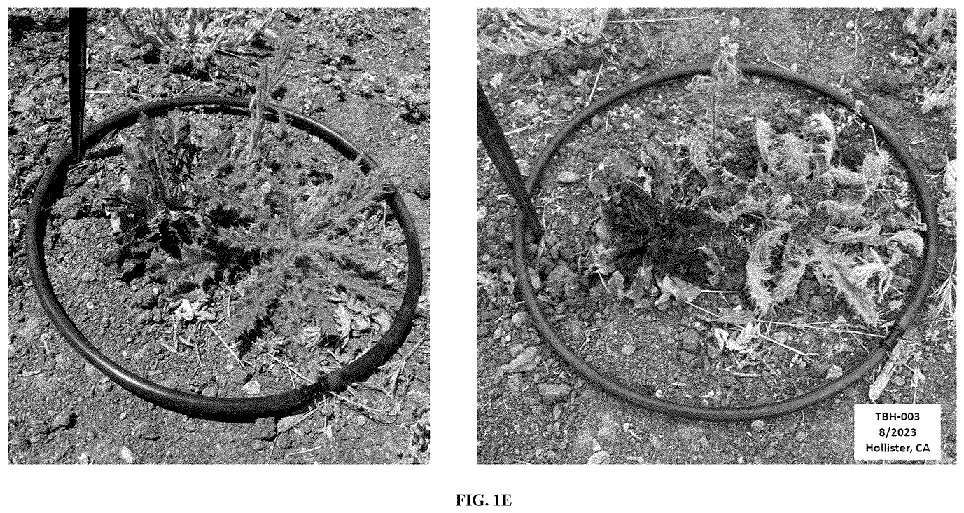

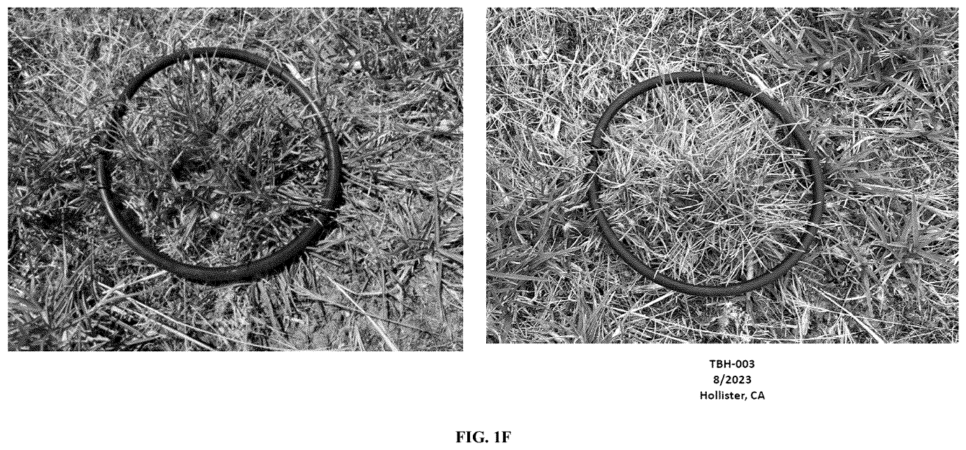

Multiple undesirable weeds were hand sprayed with a composition (TBH-003) comprising caprylic acid, vinegar, eugenol, and a surfactant using a hand sprayer (FIGS. 1A-1F). Both pre- and post-application photographs of the undesirable plants, were taken for Flaxleaf Fleabane (Erigeron bonariensus) (FIG. 1A), Prickly Lettuce (Lactuca serriola) (FIG. 1B), Willowleaf Lettuce (Lactuca saligna) (FIG. 1C), Dandelion (Taraxacum officinale) (FIG. 1D), Bull Thistle (Cirsium vulgare) (FIG. 1E), and Bermuda Grass (Cynodon dactylon) (FIG. 1F). The photographs showed that TBH-003 killed weeds of a variety of genera.

### Example 4: Compositions of the Disclosure Quickly Kill Undesirable Plants

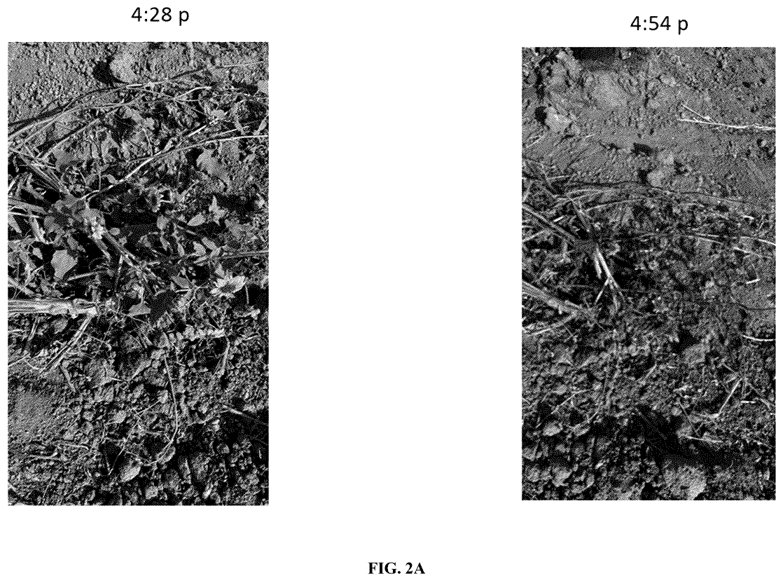

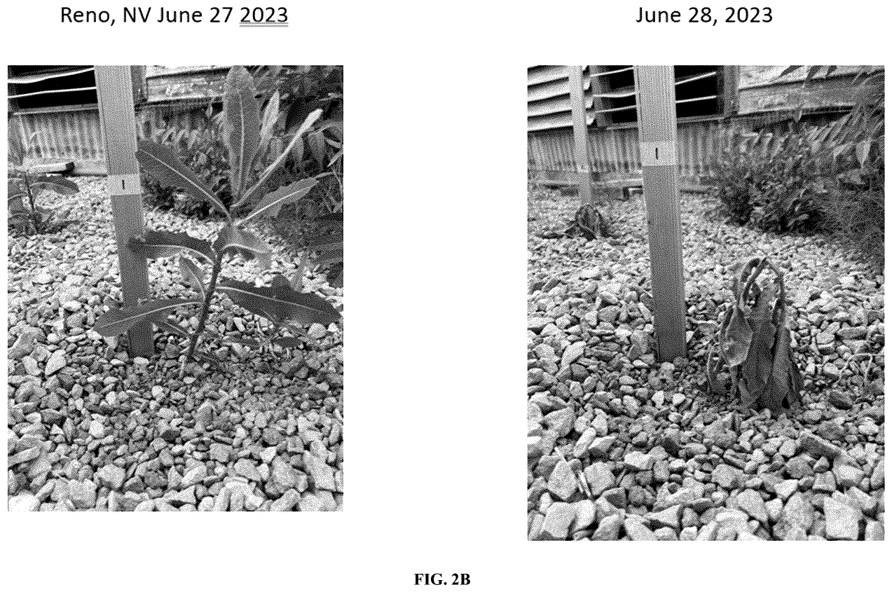

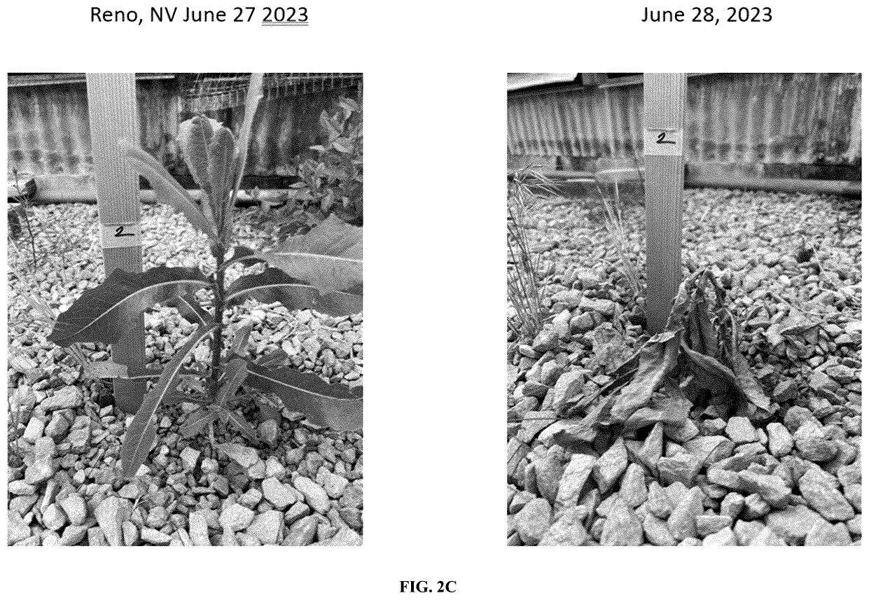

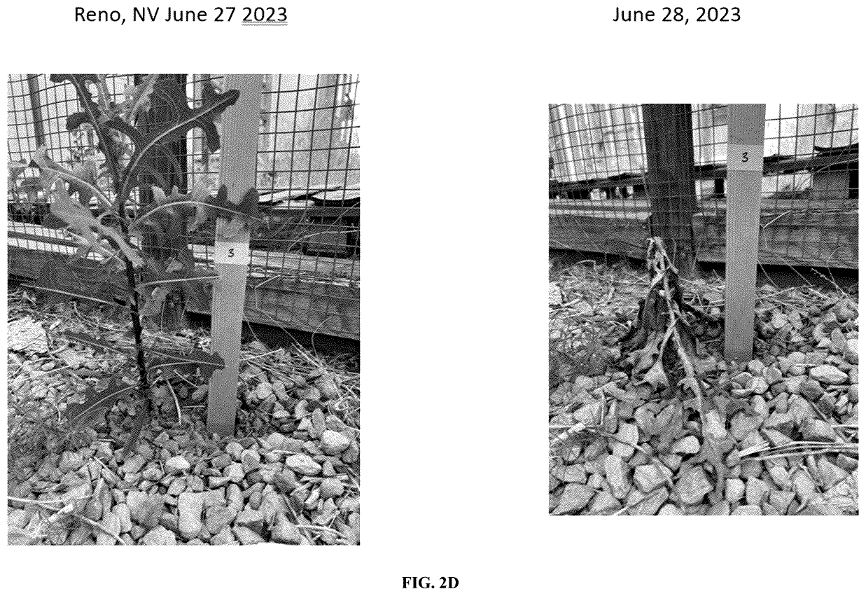

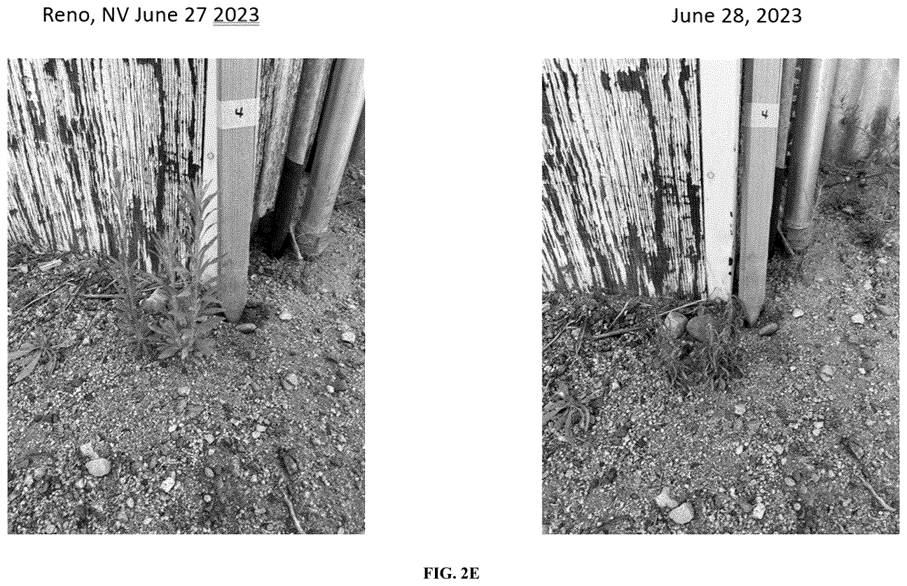

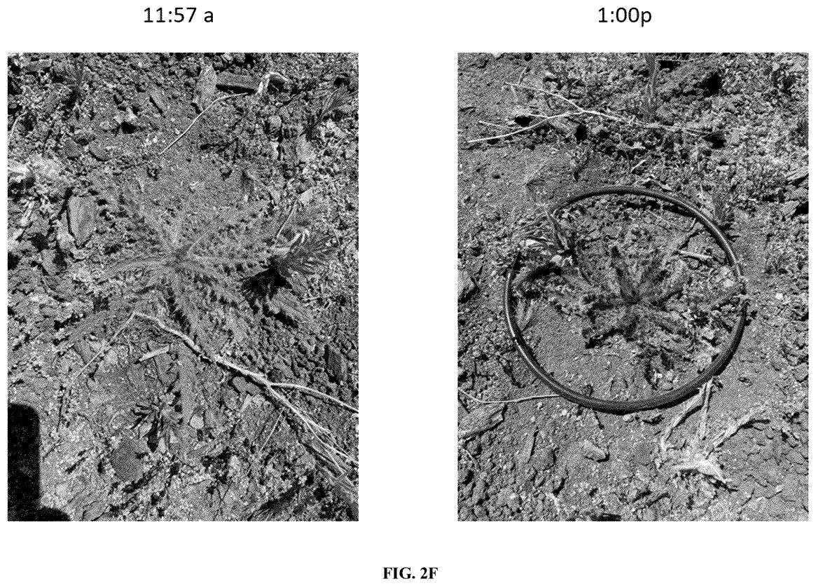

Multiple individual broadleaf and grass species were hand sprayed with a test composition containing caprylic acid, vinegar, eugenol, and a surfactant (TBH-003) using a hand sprayer. Both pre- and post-application photographs were taken for each individual plant, where the post-application photographs were taken at around 30 minutes (FIG. 2A), around 1 hour (FIG. 2F), or around 1 day (FIGS. 2B-2E) after application of the test composition. The photographs showed that TBH-003 was rapidly (within 1 day or less) killed weeds.

### Example 5: Compositions of the Disclosure Killed Undesirable Plants, without Adversely Effecting Blueberries

A study was run at a commercial organic blueberry field. Weeds, such as morning glory and Amaranthus, were predominant in the field, whereas wild mustard and some grasses were present in smaller numbers in test plots.

Furrows between the blueberry plantation infested with weeds were treated with 3 different concentrations of an herbicidal composition containing caprylic acid, vinegar, eugenol, and a surfactant (TBH-003 half rate, TBH-003 1×/Full rate, TBH-003 2×/Double rate). Each test plot measured 6 by 35 feet. A spray volume of 30 gallons per acre was used to spray on the ground with 2.5 ft wide boom and hollow cone nozzles. Observations were taken at 1, 7, and 14 days after application. No phytotoxicity of blueberry plants was detected during this study (Table 1).

TABLE 1
Phytotoxicity of Blueberries when sprayed
in furrow (Non contact with Blueberries)

| Days After First/Last Application | | | | | 1 DA-A | 7 DA-A | 7 DA-A |
|---|---|---|---|---|---|---|---|
| Treatment-Eval Interval | | | | | 9-Sep | 15-Sep | 22-Sep |
| Trt | Treatment | | Rate | Appl | | | |
| No. | Name | Rate | Unit | Code | | | |
| 1 | Untreated | | | A | 0 | 0 | 0 |
| 2 | Half Rate | 30 | gal/a | A | 0 | 0 | 0 |
| 3 | Full Rate | 30 | gal/a | A | 0 | 0 | 0 |
| 4 | Double Rate | 30 | gal/a | A | 0 | 0 | 0 |

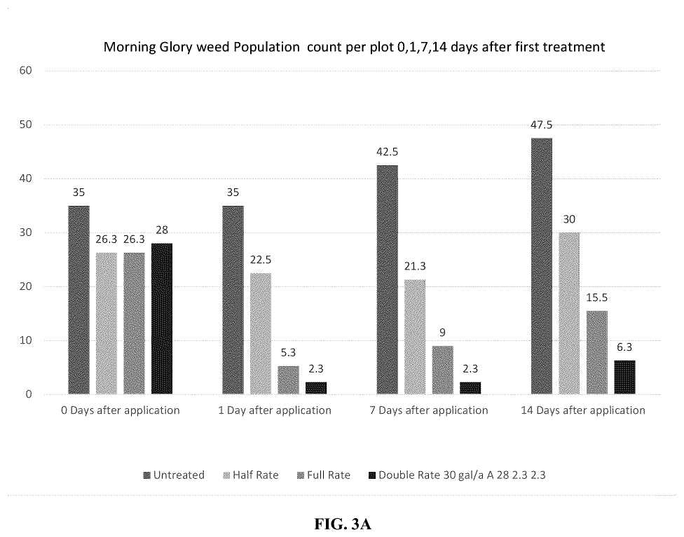

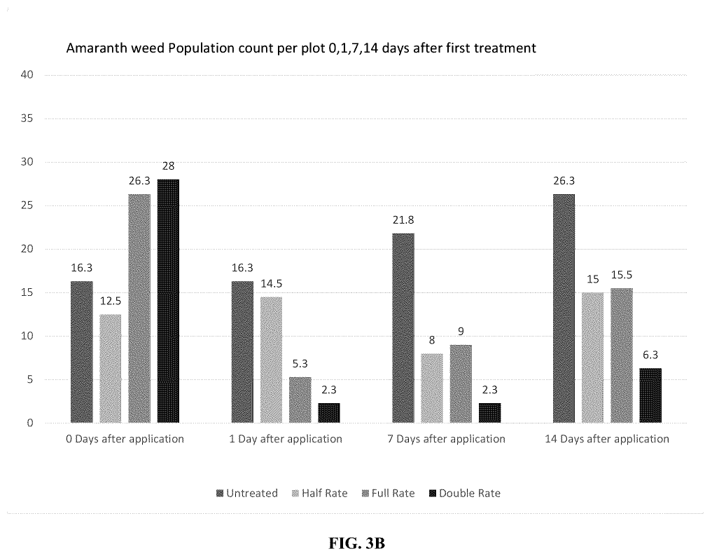

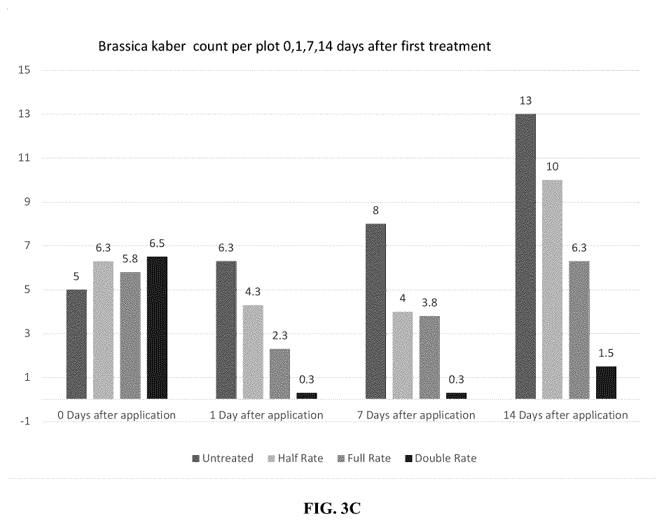

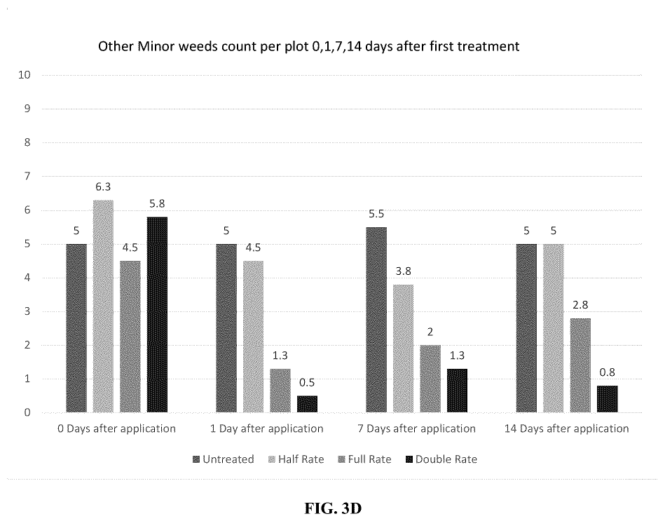

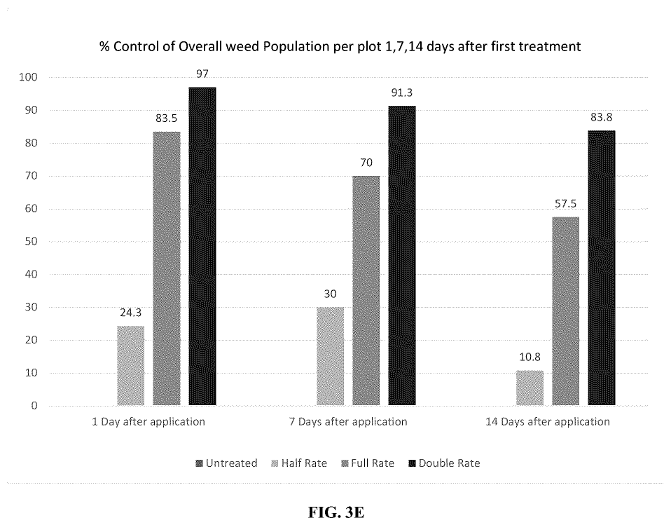

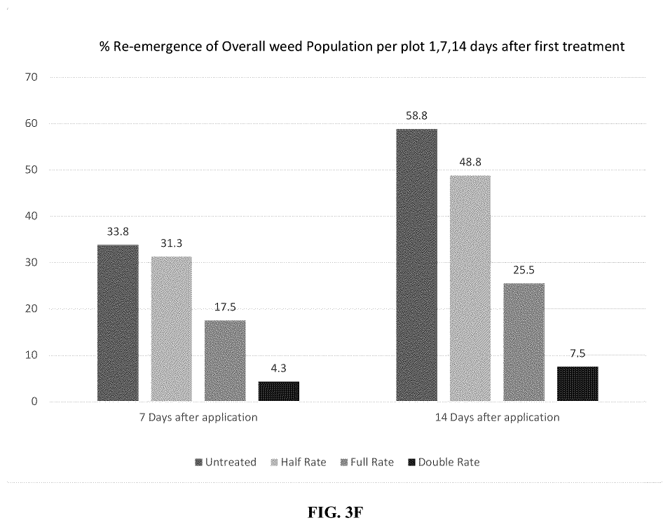

TBH-003 containing caprylic acid, vinegar, eugenol, and a surfactant at all concentration rates tested controlled the growth of morning glory (Ipomea sp.) weeds (FIG. 3A).

| Herbicide | Formulation |
|---|---|
| TBH-003 | 1.5% caprylic acid, 6.25% vinegar (4.7% |
| Half rate | acetic acid), 1.5% eugenol, 0.8% surfactant |
| TBH-003 | 3% caprylic acid, 12.5% vinegar (9.375% |
| 1X/Full rate | acetic acid), 3% eugenol, 0.8% surfactant |
| TBH-003 | 6% caprylic acid, 25% vinegar (18.75% |
| 2X/Double rate | acetic acid), 6% eugenol, 0.8% surfactant |

Untreated test plots showed increases in morning glory weed population, with new weeds emerging on a regular basis during the course of the study. In comparison, half rate treatment with TBH-003 offered moderate control of emerged morning glory after 1 and 7 days, full rate treatment offered significant treatment of morning glory after 1 and 7 days, and double rate treatment offered significant control as burndown herbicide up to 14 days (Table 2 and FIG. 3A).

TABLE 2
Morning glory weed population per plot (60 sq ft)

| Days After First/Last Application | | | | | 0 Days | 1 Day | 7 Days | 14 Days |
|---|---|---|---|---|---|---|---|---|
| | | | | | after | after | after | after |
| | | | | | application | application | application | application |
| Treatment-Eval Interval | | | | | 0 DA-A | 1 DA-A | 7 DA-A | 14 DA-A |
| | | | | | | 9-Sep | 15-Sep | 22-Sep |
| Trt | Treatment | | Rate | Appl | | | | |
| No. | Name | Rate | Unit | Code | number | | | |
| | | | | | of weeds | | | |
| | | | | | per plot | | | |
| 1 | Untreated | | | A | 35 | 35 | 42.5 | 47.5 |
| 2 | Half Rate | 30 | gal/a | A | 26.3 | 22.5 | 21.3 | 30 |
| 3 | Full Rate | 30 | gal/a | A | 26.3 | 5.3 | 9 | 15.5 |
| 4 | Double Rate | 30 | gal/a | A | 28 | 2.3 | 2.3 | 6.3 |

| | | | | |
|---|---|---|---|---|
| LSD P = .05 | 12.7 | 7.49 | 7.25 | 10.12 |
| Standard Deviation | 7.94 | 4.68 | 4.53 | 6.33 |
| CV | 27.49 | 28.83 | 24.18 | 25.49 |
| Levene's F\hat{ } | 0.171 | 0.954 | 1.876 | 0.585 |

TBH-003 at each concentration rate was able to control the growth of amaranth (Amaranthus sp.) weeds (FIG. 31B). Untreated test plots showed increases in amaranth weed population, with new weeds emerging on a regular basis. In comparison, half rate treatment with TBH-003 offered moderate control of emerged amaranth after 1 and 7 days, full rate treatment offered significant treatment of amaranth after 1 and 7 days, and double rate treatment offered significant control as burndown herbicide up to 14 days (Table 3 and FIG. 3B).

TABLE 3
Amaranth weed population per plot (60 sq ft)

| Days After First/Last Application | | | | | 0 Days | 1 Day | 7 Days | 14 Days |
|---|---|---|---|---|---|---|---|---|
| | | | | | after | after | after | after |
| | | | | | application | application | application | application |
| Treatment-Eval Interval | | | | | 0 DA-A | 1 DA-A | 7 DA-A | 14 DA-A |
| | | | | | | 9-Sep | 15-Sep | 22-Sep |
| Trt | Treatment | | Rate | Appl | | | | |
| No. | Name | Rate | Unit | Code | number | | | |
| | | | | | of weeds | | | |
| | | | | | per plot | | | |
| 1 | Untreated | | | A | 16.3 | 16.3 | 21.8 | 26.3 |
| 2 | Half Rate | 30 | gal/a | A | 12.5 | 14.5 | 8 | 15 |
| 3 | Full Rate | 30 | gal/a | A | 11.3 | 2.8 | 4.5 | 10 |
| 4 | Double Rate | 30 | gal/a | A | 19.8 | 3 | 2 | 2.3 |

| | | | | |
|---|---|---|---|---|
| LSD P = .05 | 10.16 | 7.32 | 3.79 | 5.57 |
| Standard Deviation | 6.35 | 4.57 | 2.37 | 3.48 |
| CV | 42.52 | 50.12 | 26.15 | 26.05 |
| Levene's F\hat{ } | 0.427 | 0.65 | 0.984 | 0.759 |

TBH-003 at each concentration rate controlled the growth of mustard (Brassica kaber) weeds (FIG. 3C). Untreated test plots showed increases in mustard weed population, with new weeds emerging on a regular basis. In comparison, half rate treatment with TBH-003 offered moderate control of emerged mustard after 1 and 7 days, full rate treatment offered significant treatment of mustard after 1 and 7 days, and double rate treatment offered significant control as burndown herbicide up to 14 days (Table 4 and FIG. 3C).

TABLE 4
Mustard weed population per plot (60 sq ft)

| Days After First/Last Application | | | | | 0 Days | 1 Day | 7 Days | 14 Days |
|---|---|---|---|---|---|---|---|---|
| | | | | | after | after | after | after |
| | | | | | application | application | application | application |
| Treatment-Eval Interval | | | | | 0 DA-A | 1 DA-A | 7 DA-A | 14 DA-A |
| | | | | | | 9-Sep | 15-Sep | 22-Sep |
| Trt | Treatment | | Rate | Appl | | | | |
| No. | Name | Rate | Unit | Code | number | | | |
| | | | | | of weeds | | | |
| | | | | | per plot | | | |
| 1 | Untreated | | | A | 5 | 6.3 | 8 | 13 |
| 2 | Half Rate | 30 | gal/a | A | 6.3 | 4.3 | 4 | 10 |
| 3 | Full Rate | 30 | gal/a | A | 5.8 | 2.3 | 3.8 | 6.3 |
| 4 | Double Rate | 30 | gal/a | A | 6.5 | 0.3 | 0.3 | 1.5 |

| | | | | |
|---|---|---|---|---|
| LSD P = .05 | 3.55 | 2.41 | 2.38 | 4.56 |
| Standard Deviation | 2.22 | 1.51 | 1.49 | 2.85 |
| CV | 37.74 | 46.44 | 37.27 | 37.06 |
| Levene's F\hat{ } | 0.392 | 0.021 | 2.746 | 0.582 |

TBH-003 at each concentration rate was able to control the growth of other minor weed species (FIG. 3D). Untreated test plots showed a steady population of other minor weeds. In comparison, half rate treatment with TBH-003 offered moderate control of emerged minor weeds after 1 and 7 days, full rate treatment offered strong treatment of minor weeds after 1 and 7 days, and double rate treatment offered significant control as burndown herbicide up to 14 days (Table 5 and FIG. 3D).

TABLE 5
Other minor weed species population per plot (60 sq ft)

| Days After First/Last Application | | | | | 0 Days | 1 Day | 7 Days | 14 Days |
|---|---|---|---|---|---|---|---|---|
| | | | | | after | after | after | after |
| | | | | | application | application | application | application |
| Treatment-Eval Interval | | | | | 0 DA-A | 1 DA-A | 7 DA-A | 14 DA-A |
| | | | | | | 9-Sep | 15-Sep | 22-Sep |
| Trt | Treatment | | Rate | Appl | | | | |
| No. | Name | Rate | Unit | Code | number | | | |
| | | | | | of weeds | | | |
| | | | | | per plot | | | |
| 1 | Untreated | | | A | 5 | 5 | 5.5 | 5 |
| 2 | Half Rate | 30 | gal/a | A | 6.3 | 4.5 | 3.8 | 5 |
| 3 | Full Rate | 30 | gal/a | A | 4.5 | 1.3 | 2 | 2.8 |
| 4 | Double Rate | 30 | gal/a | A | 5.8 | 0.5 | 1.3 | 0.8 |

| | | | | |
|---|---|---|---|---|
| LSD P = .05 | 2.46 | 2.14 | 1.79 | 1.79 |
| Standard Deviation | 1.54 | 1.34 | 1.12 | 1.12 |
| CV | 28.59 | 47.5 | 35.78 | 33.13 |
| Levene's F\hat{ } | 0.562 | 1.413 | 1.032 | 0.333 |

Overall, application of TBH-003 to the test plots was able to control the growth and/or survival of weed species (FIG. 3E). Half rate treatment with TBH-003 offered moderate and increasing control of emerged weeds after 1.7 days, full rate treatment offered strong early treatment of emerged weeds after 1 and 7 days, and double rate treatment offered significant control as burndown herbicide up to 14 days (Table 6 and FIG. 3E).

TABLE 6
Percent control of overall weed population per plot (60 sq ft)

| Days After First/Last Application | | | | | 1 Day | 7 Days | 14 Days |
|---|---|---|---|---|---|---|---|
| | | | | | after | after | after |
| | | | | | application | application | application |
| Treatment-Eval Interval | | | | | 1 DA-A | 7 DA-A | 14 DA-A |
| | | | | | 9-Sep | 15-Sep | 22-Sep |
| Trt | Treatment | | Rate | Appl | | | |
| No. | Name | Rate | Unit | Code | | | |
| 1 | Untreated | | | A | 0 | 0 | 0 |
| 2 | Half Rate | 30 | gal/a | A | 24.3 | 30 | 10.8 |
| 3 | Full Rate | 30 | gal/a | A | 83.5 | 70 | 57.5 |
| 4 | Double Rate | 30 | gal/a | A | 97 | 91.3 | 83.8 |

| | | | |
|---|---|---|---|
| LSD P = .05 | 3.13 | 3.83 | 6.77 |
| Standard Deviation | 1.96 | 2.39 | 4.23 |
| CV | 3.83 | 5.01 | 11.13 |
| Levene's F\hat{ } | 0.382 | 1 | 0.21 |

Application of TBH-003 at each concentration rate was also capable of controlling re-emergence of weeds (Table 7 and FIG. 3F).

TABLE 7
Percent re-emergence of weeds per plot (60 sq ft)

| Days After First/Last Application | | | | | 7 Days | 14 Days |
|---|---|---|---|---|---|---|
| | | | | | after | after |
| | | | | | application | application |
| Treatment-Eval Interval | | | | | 7 DA-A | 14 DA-A |
| | | | | | 15-Sep | 22-Sep |
| Trt | Treatment | | Rate | Appl | | |
| No. | Name | Rate | Unit | Code | | |
| 1 | Untreated | | | A | 33.8 | 58.8 |
| 2 | Half Rate | 30 | gal/a | A | 31.3 | 48.8 |
| 3 | Full Rate | 30 | gal/a | A | 17.5 | 25.5 |
| 4 | Double Rate | 30 | gal/a | A | 4.3 | 7.5 |

| | | |
|---|---|---|
| LSD P = .05 | 7 | 6.79 |
| Standard Deviation | 4.38 | 4.25 |
| CV | 20.19 | 12.09 |
| Levene's F\hat{ } | 0.551 | 1.257 |

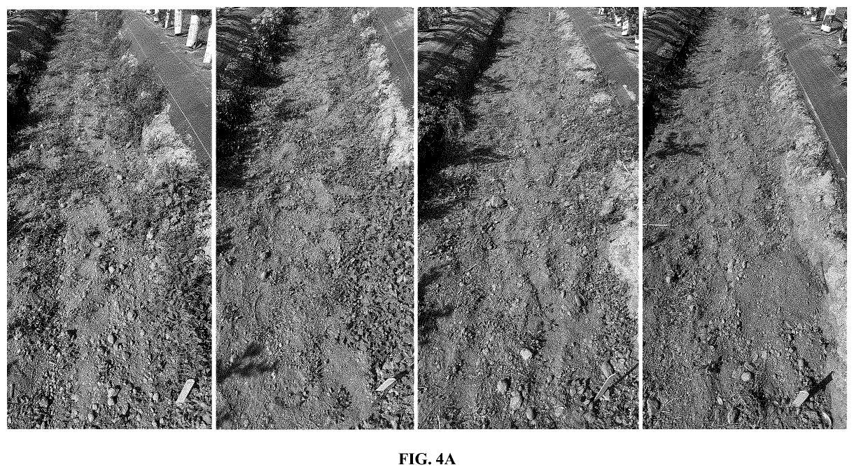

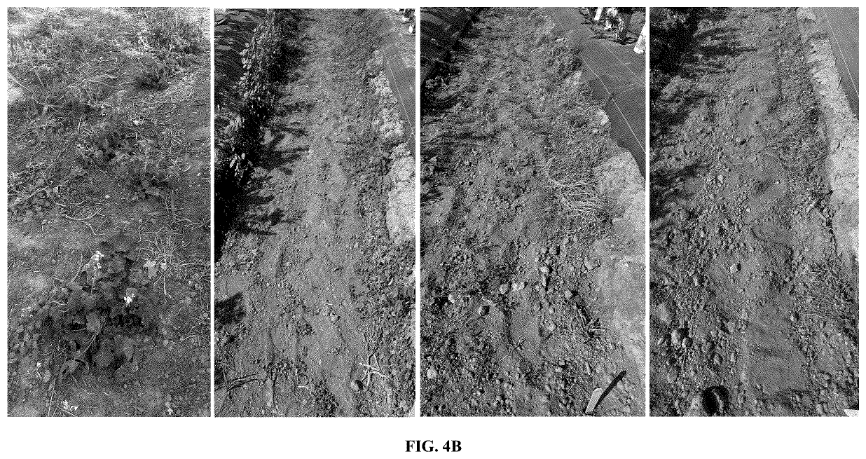

Photographs were also taken of the test plots 7 (FIG. 4A) and 14 days (FIG. 4B) after application of TBH-003, or after no treatment. The data demonstrates that half rate concentration of TBH-003 showed up to moderate control against weeds, while 1× rate and 2× rate concentrations of TBH-003 showed high control of weeds in trial plots, for at least 14 days after application.

### Example 6: Compositions of the Disclosure Showed Post Emergence Control of Dandelion and Malva Weeds

Plots infested with weeds including malva and dandelion were treated with 2 different formulations of an herbicide (TBH-003 High Cap and TBH-003 2×/Double rate) containing caprylic acid, vinegar, eugenol, and a surfactant. Test plots were also sprayed with commercially available herbicides (Suppress® and AXXE®) for comparison data. Each plot measured 5.5 by 25 feet. A spray volume of 40 gallons per acre was used to spray on the ground with 3 ft wide boom and hollow cone nozzles. Observations were taken at 1, 7 and 14 days after application.

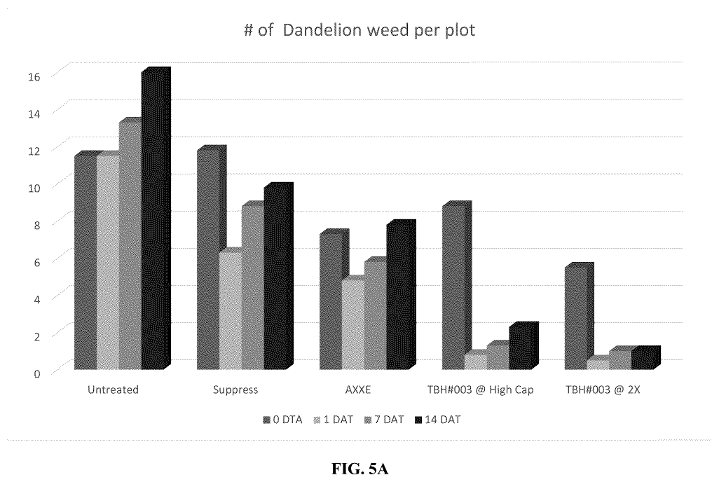

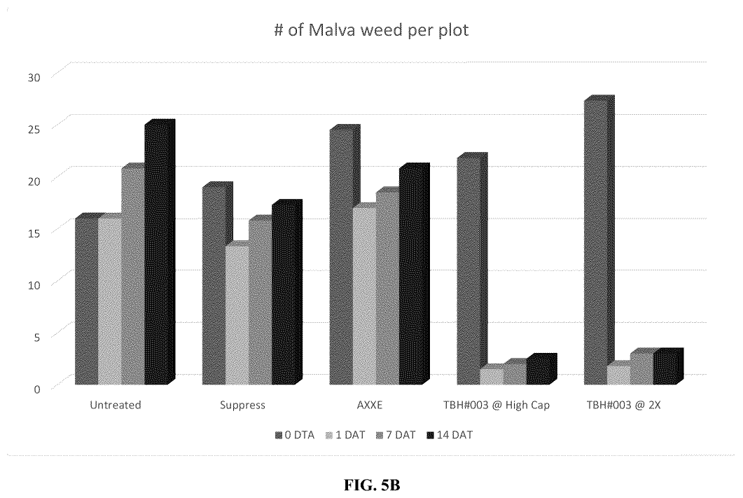

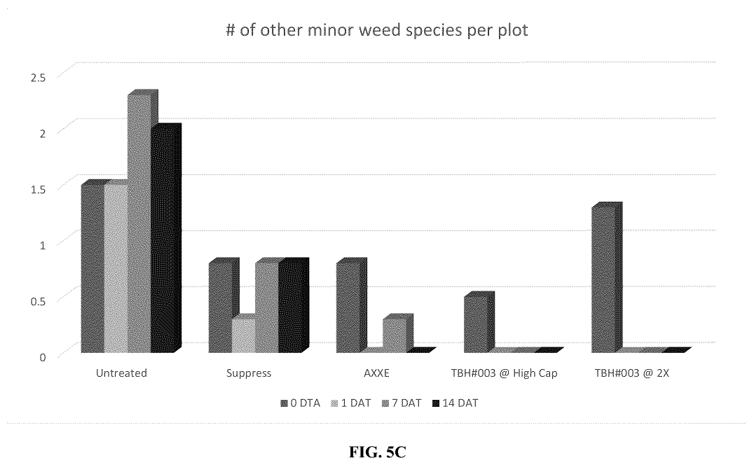

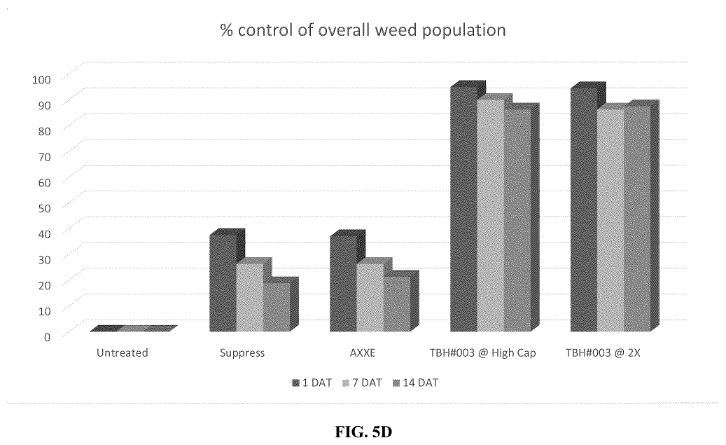

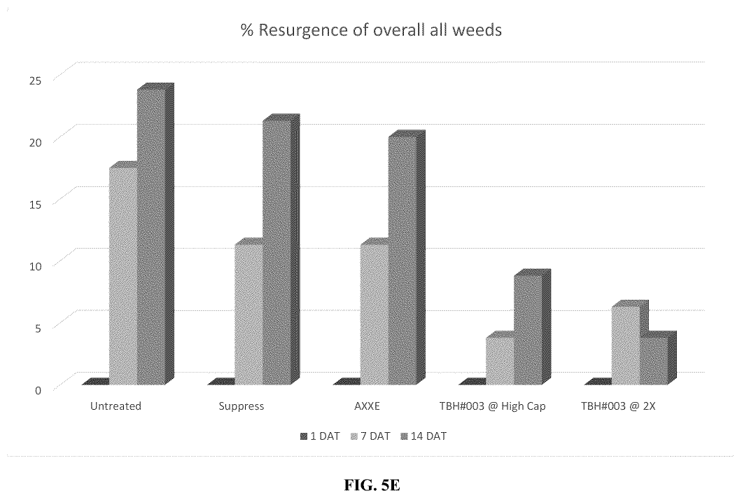

Each formulation of TBH-003 showed superior results as compared with the commercially available herbicides in controlling dandelion weed populations (FIG. 5A). Untreated plots showed an increase in dandelion weed (Taraxacum celti) population under the provided growing conditions. Suppress® showed only early numerical post emergence control of dandelion weeds, with resurgence thereafter, and AXXE® followed the same pattern of post emergence as Suppress® but with greater overall numerical control (Table 8 and FIG. 5A). In comparison, TBH-003 @High Cap and TBH-003 @2× both showed increased post emergence control of dandelion weeds as compared to the commercially available products throughout the assessment period (Table 8 and FIG. 5A).

TABLE 8
Dandelion weed population per plot

| Trt-Eval Interval | | | | | 0 DA-A | | 1 DA-A | | 7 DA-A | | 14 DA-A | |
|---|---|---|---|---|---|---|---|---|---|---|---|---|
| Trt | Treatment | | Rate | Appl | | | | | | | | |
| No. | Name | Rate | Unit | Code | | | | | | | | |
| 1 | Untreated | | | A | 11.5 | a | 11.5 | a | 13.3 | a | 16 | a |
| 2 | Suppress | 6 | % v/v | A | 11.8 | a | 6.3 | ab | 8.8 | ab | 9.8 | ab |
| 3 | AXXE | 10 | % v/v | A | 7.3 | a | 4.8 | ab | 5.8 | ab | 7.8 | ab |
| 4 | TBH#003 @ High Cap | 30 | gal/a | A | 8.8 | a | 0.8 | b | 1.3 | b | 2.3 | b |
| 5 | TBH#003 @ 2X | 30 | gal/a | A | 5.5 | a | 0.5 | b | 1 | b | 1 | b |

Each formulation of TBH-003 showed superior results as compared with the commercially available herbicides in controlling malva weed populations (FIG. 5B). Untreated plots showed an increase in malva weed/common mallow (Malva neglecta) population under the provided growing conditions. Suppress® showed marginal post emergence control of malva weeds, with resurgence thereafter, and AXXE® followed the same pattern of post emergence as Suppress® but with reduced overall numerical control (Table 9 and FIG. 5B). In comparison, TBH-003 @High Cap and TBH-003 @2× both showed increased post emergence control of malva weeds as compared to the commercially available products throughout the assessment period (Table 9 and FIG. 5B).

TABLE 9
Malva weed population per plot

| Trt-Eval Interval | | | | | 0 DA-A | | 1 DA-A | | 7 DA-A | | 14 DA-A | |
|---|---|---|---|---|---|---|---|---|---|---|---|---|
| Trt | Treatment | | Rate | Appl | | | | | | | | |
| No. | Name | Rate | Unit | Code | | | | | | | | |
| 1 | Untreated | | | A | 16 | a | 16 | a | 20.8 | a | 25 | a |
| 2 | Suppress | 6 | % v/v | A | 19 | a | 13.3 | a | 15.8 | a | 17.3 | a |
| 3 | AXXE | 10 | % v/v | A | 24.5 | a | 17 | a | 18.5 | a | 20.8 | a |
| 4 | TBH#003 @ High Cap | 30 | gal/a | A | 21.8 | a | 1.5 | b | 2 | b | 2.5 | b |
| 5 | TBH#003 @ 2X | 30 | gal/a | A | 27.3 | a | 1.8 | b | 3 | b | 3 | b |

Each formulation of TBH-003 was able to provide significant control of minor weed populations (FIG. 5C). Untreated plots showed an increase in minor weed population under the provided growing conditions. Suppress® showed significant control of minor weeds, with minor resurgence thereafter, and AXXE® showed greater overall control of minor weeds as compared to Suppress® (Table 10 and FIG. 5C). TBH-003 @High Cap and TBH-003 @2× both showed significant control of minor weeds throughout the assessment period (Table 10 and FIG. 5C).

TABLE 10
Other minor weed species population per plot

| Trt-Eval Interval | | | | | 0 DA-A | | 1 DA-A | | 7 DA-A | | 14 DA-A | |
|---|---|---|---|---|---|---|---|---|---|---|---|---|
| Trt | Treatment | | Rate | Appl | | | | | | | | |
| No. | Name | Rate | Unit | Code | | | | | | | | |
| 1 | Untreated | | | A | 1.5 | a | 1.5 | a | 2.3 | a | 2 | a |
| 2 | Suppress | 6 | % v/v | A | 0.8 | a | 0.3 | b | 0.8 | b | 0.8 | a |
| 3 | AXXE | 10 | % v/v | A | 0.8 | a | 0 | b | 0.3 | b | 0 | b |
| 4 | TBH#003 @ High Cap | 30 | gal/a | A | 0.5 | a | 0 | b | 0 | b | 0 | b |
| 5 | TBH#003 @ 2X | 30 | gal/a | A | 1.3 | a | 0 | b | 0 | b | 0 | b |

Each formulation of TBH-003 showed superior results as compared with the commercially available herbicides in overall control of weed populations (FIG. 5D). With data from the untreated plots as a negative control, Suppress® showed statistically different control post emergence control with minor resurgence thereafter and AXXE® showed greater overall statistically different control compared to Suppress. In comparison, TBH-003 @High Cap and TBH-003 @2× both showed increased overall control of weeds as compared to the commercially available products throughout the assessment period (Table 11 and FIG. 5D).

TABLE 11
Percent overall control of weed population per plot

| | | | | | % control | | % control | | % control | |
|---|---|---|---|---|---|---|---|---|---|---|
| Trt | Treatment | | Rate | Appl | 1 DA-A | | 7 DA-A | | 14 DA-A | |
| No. | Name | Rate | Unit | Code | | | | | | |
| 1 | Untreated | | | A | 0 | c | 0 | c | 0 | c |
| 2 | Suppress | 6 | % v/v | A | 37.5 | b | 26.3 | b | 18.8 | b |
| 3 | AXXE | 10 | % v/v | A | 37 | b | 26.3 | b | 21.3 | b |
| 4 | TBH#003 @ High Cap | 30 | gal/a | A | 95 | a | 90 | a | 86.3 | a |
| 5 | TBH#003 @ 2X | 30 | gal/a | A | 94.5 | a | 86.3 | a | 87.5 | a |

Each formulation of TBH-003 showed superior results as compared with the commercially available herbicides in prevention of re-emergence of weed populations (FIG. 5E). With data from the untreated plots as a negative control, Suppress® showed numerically different resurgence control, and AXXE® showed greater overall numerically different resurgence control compared to Suppress®. In comparison, TBH-003 @High Cap and TBH-003 @2× both showed a reduction in post-treatment re-emergence of weeds as compared to the commercially available products throughout the assessment period (Table 12 and FIG. 5E).

TABLE 12
Percent re-emergence of weeds per plot

| Trt-Eval Interval | | | | | 1 DA-A | | 7 DA-A | | 14 DA-A | |
|---|---|---|---|---|---|---|---|---|---|---|
| Trt | Treatment | | Rate | Appl | | | | | | |
| No. | Name | Rate | Unit | Code | | | | | | |
| 1 | Untreated | | | A | 0 | — | 17.5 | a | 23.8 | a |
| 2 | Suppress | 6 | % v/v | A | 0 | — | 11.3 | ab | 21.3 | a |
| 3 | AXXE | 10 | % v/v | A | 0 | — | 11.3 | ab | 20 | a |
| 4 | TBH#003 @ High Cap | 30 | gal/a | A | 0 | — | 3.8 | b | 8.8 | b |
| 5 | TBH#003 @ 2X | 30 | gal/a | A | 0 | — | 6.3 | b | 3.8 | b |

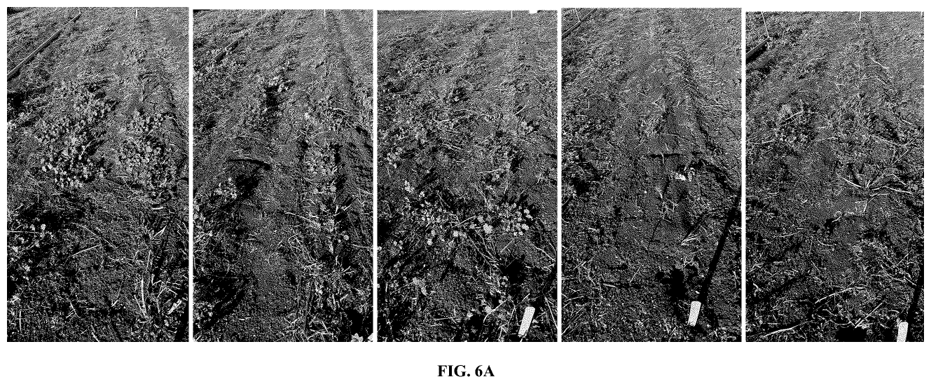

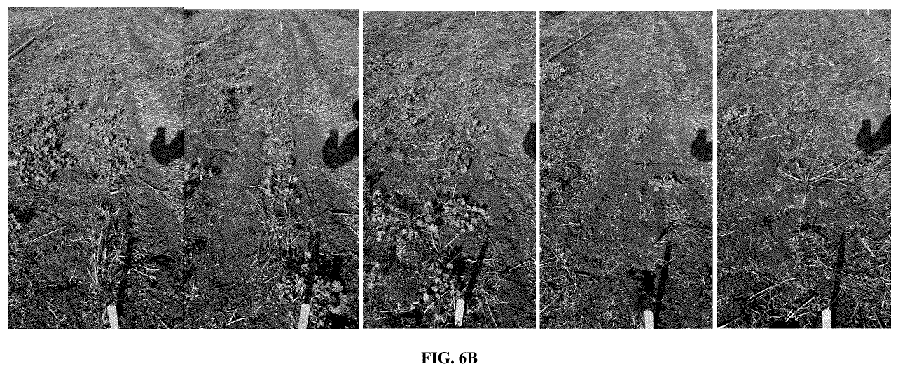

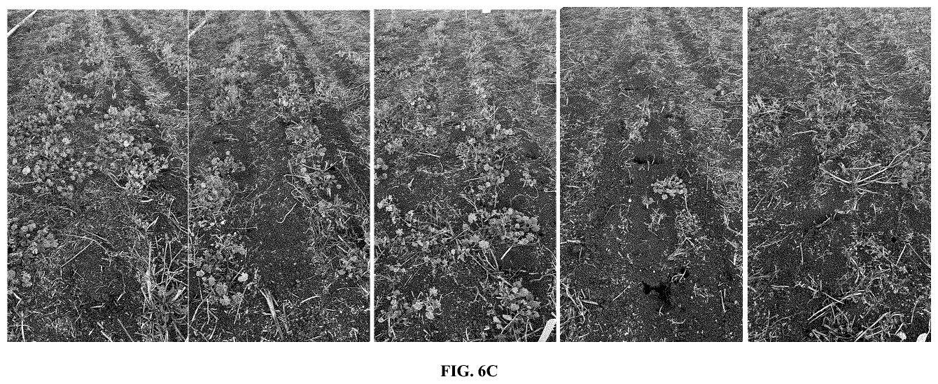

Photographs were also taken of the test plots 1, 7, and 14 days after application of each test condition (FIGS. 6A-6C). In sum, both TBH-003 @High Cap and TBH-003 2×/Double rate showed significant weed control for at least 14 days after application, and showed significant improvements over commercially available products.

### Example 7: Compositions of the Disclosure Showed Effective Control of Insect Species

The compositions disclosed herein were tested for their ability to control various insect species. The following insect species were selected for testing: (i) Adult Myzus persicae (i.e., Peach potato aphid); (ii) Adult Frankliniella occidentalis (i.e., Western flower thrip); and (iii) Adult Tenebrio molitor (i.e., Mealworm beetle).

TBH-003 1×/Full Rate was diluted as according to the table below to produce a single spray run.

TABLE 13
TBH-003 1X Dilution Table

| | Product | Water | Total |
|---|---|---|---|
| | (μl) | (ml) | (ml) |
| Control | 0 | 15 | 15 |
| 1:10 | 1500 | 13.500 | 15 |
| 1:100 | 150 | 14.85 | 15 |
| 1:1000 | 15 | 14.985 | 15 |

10 adult aphids, thrips, or beetles were plated on each 9 cm Petri dish. 3 replicate Petri dishes were prepared for each species, for each spray run, for a total of 9 Petri dishes/spray run. A 15 mL dilution (according to Table 13) of TBH-003 1×/Full rate was then applied to each of the 9 dishes in the spray run, for a total spray are of 0.5 m². The spray volume per spray run was therefore 30 mL/m² or 300 L/ha.

The results of a first set of spray runs for each dilution in Table 13 are provided in the Tables below.

TABLE 14
First spray run (% total)

| | | Live, knock-down or dead insects (%) | | | | | | | | |
|---|---|---|---|---|---|---|---|---|---|---|
| | | 6 hours post | | | 24 hours post | | | 48 hours post | | |
| | | treatment | | | treatment | | | treatment | | |
| | | | K- | | | K- | | | K- | |
| | Treatment | Live | down | Dead | Live | down | Dead | Live | down | Dead |
| Aphid | Control | 100 | 0 | 0 | 100 | 0 | 0 | 97 | 0 | 3 |
| | (water) | | | | | | | | | |
| | 0.001 | 97 | 0 | 3 | 90 | 7 | 3 | 86 | 0 | 14 |
| | 0.01 | 96 | 0 | 4 | 96 | 4 | 0 | 96 | 0 | 4 |
| | 0.1 | 20 | 73 | 7 | 67 | 6 | 27 | 57 | 0 | 43 |
| Thrip | Control | 69 | 0 | 31 | 69 | 0 | 31 | 69 | 0 | 31 |
| | (water) | | | | | | | | | |
| | 0.001 | 96 | 0 | 4 | 93 | 0 | 7 | 78 | 0 | 12 |
| | 0.01 | 93 | 0 | 7 | 96 | 0 | 4 | 77 | 0 | 3 |
| | 0.1 | 0 | 0 | 100 | 0 | 0 | 100 | 0 | 0 | 100 |
| Beetle | Control | 95 | 5 | 0 | 81 | 0 | 19 | 81 | 0 | 19 |
| | (water) | | | | | | | | | |
| | 0.001 | 100 | 0 | 0 | 100 | 0 | 0 | 100 | 0 | 0 |
| | 0.01 | 95 | 0 | 5 | 95 | 0 | 5 | 95 | 0 | 5 |
| | 0.1 | 100 | 0 | 0 | 100 | 0 | 0 | 100 | 0 | 0 |

TABLE 15
First spray run (raw numbers per dish)

| | | | 6 h post | | | 24 h post | | | 48 h post | | |
|---|---|---|---|---|---|---|---|---|---|---|---|
| | | | treatment | | | treatment | | | treatment | | |
| | | Rep. | Nos | Nos | Nos | Nos | Nos | Nos | Nos | Nos | Nos |
| Treatment | Species | no | Live | K-D | Dead | Live | K-D | Dead | Live | K-D | Dead |
| Control | M. persicae | 1 | 10 | 0 | 0 | 10 | 0 | 0 | 10 | 0 | 0 |
| (water) | | 2 | 9 | 0 | 0 | 9 | 0 | 0 | 8 | 0 | 1 |
| | | 3 | 10 | 0 | 0 | 10 | 0 | 0 | 10 | 0 | 0 |
| | F. | 1 | 2 | 0 | 3 | 2 | 0 | 3 | 2 | 0 | 3 |
| | occidentalis | 2 | 2 | 0 | 1 | 2 | 0 | 1 | 2 | 0 | 1 |
| | | 3 | 5 | 0 | 0 | 5 | 0 | 0 | 5 | 0 | 0 |
| | T. molitor | 1 | 6 | 1 | 0 | 4 | 0 | 3 | 4 | 0 | 3 |
| | | 2 | 7 | 0 | 0 | 7 | 0 | 0 | 7 | 0 | 0 |
| | | 3 | 7 | 0 | 0 | 6 | 0 | 1 | 6 | 0 | 1 |
| 0.001 | M. persicae | 1 | 10 | 0 | 0 | 10 | 0 | 0 | 10 | 0 | 0 |
| dilution | | 2 | 9 | 0 | 0 | 9 | 0 | 0 | 9 | 0 | 0 |
| | | 3 | 9 | 0 | 1 | 7 | 2 | 1 | 6 | 0 | 4 |
| | F. | 1 | 7 | 0 | 0 | 6 | 0 | 1 | 5 | 0 | 2 |
| | occidentalis | 2 | 12 | 0 | 0 | 12 | 0 | 0 | 6 | 0 | 2 |
| | | 3 | 7 | 0 | 1 | 7 | 0 | 1 | 7 | 0 | 1 |
| | T. molitor | 1 | 7 | 0 | 0 | 7 | 0 | 0 | 7 | 0 | 0 |
| | | 2 | 7 | 0 | 0 | 7 | 0 | 0 | 7 | 0 | 0 |
| | | 3 | 7 | 0 | 0 | 7 | 0 | 0 | 7 | 0 | 0 |
| 0.01 | M. persicae | 1 | 9 | 0 | 0 | 9 | 0 | 0 | 9 | 0 | 0 |
| dilution | | 2 | 9 | 0 | 0 | 9 | 0 | 0 | 9 | 0 | 0 |
| | | 3 | 7 | 0 | 1 | 7 | 1 | 0 | 7 | 0 | 1 |
| | F. | 1 | 9 | 0 | 1 | 10 | 0 | 0 | 3 | 0 | 0 |
| | occidentalis | 2 | 9 | 0 | 1 | 9 | 0 | 1 | 1 | 0 | 1 |
| | | 3 | 7 | 0 | 0 | 7 | 0 | 1 | 6 | 0 | 2 |
| | T. molitor | 1 | 7 | 0 | 0 | 7 | 0 | 0 | 7 | 0 | 0 |
| | | 2 | 6 | 0 | 1 | 6 | 0 | 1 | 6 | 0 | 1 |
| | | 3 | 7 | 0 | 0 | 7 | 0 | 0 | 7 | 0 | 0 |
| 0.1 | M. persicae | 1 | 2 | 8 | 0 | 8 | 0 | 2 | 8 | 0 | 2 |
| dilution | | 2 | 1 | 7 | 2 | 4 | 1 | 5 | 4 | 0 | 6 |
| | | 3 | 3 | 7 | 0 | 8 | 1 | 1 | 5 | 0 | 5 |
| | F. | 1 | 0 | 0 | 6 | 0 | 0 | 6 | 0 | 0 | 6 |
| | occidentalis | 2 | 0 | 0 | 9 | 0 | 0 | 9 | 0 | 0 | 9 |
| | | 3 | 0 | 0 | 11 | 0 | 0 | 11 | 0 | 0 | 11 |
| | T. molitor | 1 | 5 | 0 | 0 | 5 | 0 | 0 | 5 | 0 | 0 |
| | | 2 | 5 | 0 | 0 | 5 | 0 | 0 | 5 | 0 | 0 |
| | | 3 | 7 | 0 | 0 | 7 | 0 | 0 | 7 | 0 | 0 |

As can be seen above, dilutions of TBH-003 1× were especially effective at controlling aphid and thrip populations.

A repeat spray run for thrips only was performed under the same conditions. The results are shown in the Table below.

TABLE 16
Thrip-only repeat spray run (% total)

| | | Live, knock-down or dead insects (%) | | | | | | | | |
|---|---|---|---|---|---|---|---|---|---|---|
| | | 6 hours post | | | 24 hours post | | | 48 hours post | | |
| | | treatment | | | treatment | | | treatment | | |
| | | | K- | | | K- | | | K- | |
| | Treatment | Live | down | Dead | Live | down | Dead | Live | down | Dead |
| Thrip | Control | 95 | 0 | 5 | 89 | 0 | 11 | 70 | 0 | 30 |
| | (water) | | | | | | | | | |
| | 0.001 | 92 | 0 | 8 | 76 | 0 | 24 | 63 | 0 | 37 |
| | 0.01 | 96 | 0 | 4 | 89 | 0 | 11 | 77 | 0 | 23 |
| | 0.1 | 0 | 0 | 100 | 0 | 0 | 100 | 0 | 0 | 100 |

TABLE 17
Thrip-only repeat spray run (raw numbers per dish)

| | | | 6 h post | | | 24 h post | | | 48 h post | | |
|---|---|---|---|---|---|---|---|---|---|---|---|
| | | | treatment | | | treatment | | | treatment | | |
| | | Rep. | Nos | Nos | Nos | Nos | Nos | Nos | Nos | Nos | Nos |
| Treatment | Species | no | Live | K-D | Dead | Live | K-D | Dead | Live | K-D | Dead |
| Control | F. | 1 | 10 | 0 | 1 | 8 | 0 | 1 | 4 | 0 | 1 |
| (water) | occidentalis | 2 | 14 | 0 | 0 | 11 | 0 | 2 | 3 | 0 | 4 |
| | | 3 | 10 | 0 | 1 | 14 | 0 | 1 | 12 | 0 | 3 |
| 0.001 | F. | 1 | — | — | — | — | — | — | — | — | — |
| | occidentalis | 2 | 11 | 0 | 1 | 9 | 0 | 2 | 7 | 0 | 4 |
| | | 3 | 11 | 0 | 1 | 7 | 0 | 3 | 5 | 0 | 3 |
| 0.01 | F. | 1 | 10 | 0 | 0 | 8 | 0 | 0 | 4 | 0 | 1 |
| | occidentalis | 2 | 9 | 0 | 1 | 8 | 0 | 2 | 7 | 0 | 4 |
| | | 3 | 9 | 0 | 0 | 9 | 0 | 1 | 9 | 0 | 1 |
| 0.1 | F. | 1 | 0 | 0 | 12 | 0 | 0 | 12 | 0 | 0 | 12 |
| | occidentalis | 2 | 0 | 0 | 11 | 0 | 0 | 11 | 0 | 0 | 11 |
| | | 3 | 0 | 0 | 14 | 0 | 0 | 14 | 0 | 0 | 14 |

As can be seen above, the results validated the effectiveness of dilutions of TBH-003 1× in killing and/or controlling thrips.

### Example 8: Compositions of the Disclosure Showed Effective Control of Nematode Species

The compositions disclosed herein were tested for their ability to control nematode species. The nematode species Meloidogyne incognita (i.e., root-knot nematode) was chosen for experimentation.

TBH-003 1×/Full Rate was diluted according to the Table below to produce 15 mL of agar and TBH-003 mix for plating.

TABLE 18
Agar/TBH-003 dilution plates

| | Product | Water | 0.3% Agar | |
|---|---|---|---|---|
| | (μl) | (ml) | (ml) | (ml) |
| Control | 0 | 1.5 | 13.5 | 15 |
| 1:10 | 1500 | 0.000 | 13.5 | 15 |
| 1:100 | 150 | 1.350 | 13.5 | 15 |
| 1:1000 | 15 | 1.485 | 13.5 | 15 |

Adult nematodes were plated for each Petri dish. 3 replicate Petri dishes were prepared for each dilution.

Results for each replicate dish in each dilution condition are shown in the Table below.

TABLE 19
Effect of TBH-003 containing medium on nematode populations

| | Nematode type | | | | |
|---|---|---|---|---|---|
| | Root-knot | | | | |
| | nematode | 24 h | Comment | 72 h | Comment |
| Compound | Rep 1 | 3 | D | 3 | D |
| 1:10 | Rep 2 | 3 | D | 3 | D |
| | Rep 3 | 3 | D | 3 | D |
| Compound | Rep 1 | 3 | D | 3 | D |
| 1:100 | Rep 2 | 3 | D | 3 | D |
| | Rep 3 | 3 | D | 3 | D |
| Compound | Rep 1 | 1 | B | 1 | B |
| 1:1000 | Rep 2 | 1 | B | 1 | B |
| | Rep 3 | 1 | B | 1 | B |
| Negative | Rep 1 | 0 | A | 0 | A |
| control | Rep 2 | 0 | A | 0 | A |
| Compound | Rep 3 | 0 | A | 0 | A |
| 0 L/ha | | | | | |

0 = No effect
1 = Nematode disorientation/agitation
2 = Nematode paralysis
3 = Nematode death
A = Alive, moving towards root exudates
B = Disorientation/agitated jerky movement still within inoculation area
C = No movement from inoculation area, alive, paralysis
D = No movement from inoculation area, dead, lipids degrading/nematodes clearing

As can be seen in the results above, TBH-003 1× dilutions into media were effective in controlling and/or killing nematodes.

The results described herein above were obtained using the following methods and materials.

### Methods and Materials

The following tables describe the formulations used in the above Examples.

TABLE 13
Herbicidal formulations used

| Herbicide | Formulation |
|---|---|
| TBH-003 | 1.5% caprylic acid, 6.25% vinegar (4.7% |
| Half rate | acetic acid), 1.5% eugenol, 0.8% surfactant |
| TBH-003 | 3% caprylic acid, 12.5% vinegar (9.375% |
| 1X/Full rate | acetic acid), 3% eugenol, 0.8% surfactant |
| TBH-003 | 6% caprylic acid, 25% vinegar (18.75% |
| 2X/Double rate | acetic acid), 6% eugenol, 0.8% surfactant |
| TBH-003 | 9% caprylic acid, 12.5% vinegar (9.375% |
| High Cap | acetic acid), 3% eugenol, 0.8% surfactant |
| Suppress ® | caprylic and capric acid 6% concentration |
| AXXE ® | Ammonium nonanoate 10% concentration |

Percentages in Table 13 above are displayed in (vol/vol)%

TABLE 14
Insecticidal/Nematocidal formulations used

| Dilution | Formulation |
|---|---|
| 1:10 Dilution | 1500 μL of TBH-003 1X/Full |
| | rate diluted in 13.5 mL of water |
| 1:100 Dilution | 150 μL of TBH-003 1X/Full |
| | rate diluted in 13.5 mL of water |
| 1:1000 Dilution | 15 μL of TBH-003 1X/Full |
| | rate diluted in 13.5 mL of water |

### OTHER EMBODIMENTS

From the foregoing description, it will be apparent that variations and modifications may be made to the invention described herein to adapt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

What is claimed is:

1. A composition comprising:
between about 1% (vol/vol) to about 15% (vol/vol) fatty acid;
between about 0.25% (vol/vol) to about 30% (vol/vol) organic acid;
between about 1% (vol/vol) to about 10% (vol/vol) of an essential oil or phenolic extract thereof; and
between about 0.5% (vol/vol) to about 3% (vol/vol) surfactant.

2. The composition of claim 1, wherein the fatty acid is capric, caprylic, or nonanoic acid, or ammonium nonanoate.

3. The composition of claim 1, wherein the organic acid is vinegar, formic acid, acetic acid, propionic acid, or butyric acid.

4. The composition of claim 1, wherein the surfactant is alcohol ethoxylate and/or sodium lauryl ether sulfate.

5. The composition of claim 1, wherein the essential oil is eugenol, thymol, or carvacrol.

6. A ready-to-use insecticidal or nematocidal composition, the ready-to-use composition comprising the composition of claim 1 diluted at a ratio of between about 1:10 to 1:1000.

7. A method of killing a plant, the method comprising: contacting a plant, soil proximal to the plant, and/or an environment of the plant with the composition of claim 1, thereby killing the plant.

8. The method of claim 7, wherein the method kills the plant within 24-hours of contact.

9. A method of reducing plant growth, the method comprising: contacting a plant, soil proximal to the plant, and/or an environment of the plant with the composition of claim 1, thereby reducing growth of the plant.

10. The method of claim 9, wherein the method results in a reduction in plant growth, as compared to contacting the plant with a reference herbicidal composition.

11. A method of reducing the survival of a plant, the method comprising: contacting a plant, a soil proximal to the plant, and/or an environment of the plant with the composition of claim 1, thereby reducing survival of the plant.

12. The method of claim 11, wherein the method results in a decrease in survival of the plant, as compared to contacting the plant with a reference herbicidal composition.

13. A method of reducing re-emergence of a plant, the method comprising: contacting a plant, a soil proximal to the plant, and/or an environment of the plant with the composition of claim 1, thereby reducing re-emergence of the plant.

14. The method of claim 13, wherein the method results in a decrease in re-emergence of the plant, as compared contacting the plant with a reference herbicidal composition.

15. The method of claim 13, wherein re-emergence of the plant is reduced for at least 7 days after the contacting.

16. The method of claim 9, wherein growth of the plant is reduced within 24 hours of the contacting.

17. A method of killing an insect or nematode, the method comprising: contacting an insect or nematode, soil proximal to the insect or nematode, and/or an environment of the insect or nematode with the composition of claim 6, thereby killing the insect or nematode.

18. A method of reducing the survival of an insect or nematode, the method comprising:
contacting an insect or nematode, a soil proximal to the insect or nematode, and/or an environment of the insect or nematode with the composition of claim 6, thereby reducing survival of the insect or nematode.

19. The method of claim 18, wherein the insect is M. persicae or F. occidentalis.

20. The method of claim 18, wherein the nematode is M. incognita.
